(19) United States
(12) Patent Application Publication
(10) Pub. No.: US 2023/0254819 A1
(43) Pub. Date: Aug. 10, 2023

(54) METHOD AND APPARATUS FOR (RE)SELECTION OF CANDIDATE CARRIERS FOR TRANSMISSION IN SL CA

(71) Applicant: Samsung Electronics Co., Ltd., Suwon-si (KR)

(72) Inventor: Kyeongin Jeong, Allen, TX (US)

(21) Appl. No.: 18/160,300

(22) Filed: Jan. 26, 2023

Related U.S. Application Data
(60) Provisional application No. 63/306,869, filed on Feb. 4, 2022.
(60) Provisional application No. 63/353,399, filed on Jun. 17, 2022.

(51) Int. Cl. H04W 72/02; H04W 72/0453; H04W 72/54; H04W 76/20; H04W 72/563; H04W 72/25

(52) U.S. Cl. CPC H04W 72/02; H04W 72/0453; H04W 72/54; H04W 76/20; H04W 72/563; H04W 72/25

(57) ABSTRACT

Methods and apparatuses for a (re)selection of candidate carriers for transmission in SL CA in a wireless communication system. A method of operating a UE includes: receiving, from a peer UE, an RSRP; identifying information including a first threshold and a second threshold for a sidelink (SL) transmission; determining whether multiple SL carriers are available for the SL transmission; measuring, based on a determination that the multiple SL carriers are available, a CBR; and selecting a SL carrier from the multiple SL carriers for the SL transmission when the measured CBR is less than the first threshold and the received RSRP is greater than the second threshold.

### CROSS-REFERENCE TO RELATED APPLICATIONS AND CLAIM OF PRIORITY

The present application claims priority to U.S. Provisional Patent Application No. 63/306,869, filed on Feb. 4, 2022; and U.S. Provisional Patent Application No. 63/353,399, filed on Jun. 17, 2022. The contents of the above-identified patent documents are incorporated herein by reference.

### TECHNICAL FIELD

The present disclosure relates generally to wireless communication systems and, more specifically, the present disclosure relates to a (re)selection of candidate carriers for transmission in sidelink (SL) carrier aggregation (CA) in a wireless communication system.

### BACKGROUND

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

The present disclosure relates to wireless communication systems and, more specifically, the present disclosure relates to a (re)selection of candidate carriers for transmission in SL CA in a wireless communication system.

In one embodiment, a user equipment (UE) in a wireless communication system is provided. The UE comprises a transceiver configured to receive, from a peer UE, a reference signal received power (RSRP). The UE further comprises a processor operably coupled to the transceiver, the processor configured to: identify information including a first threshold and a second threshold for a sidelink (SL) transmission; determine whether multiple SL carriers are available for the SL transmission, measure, based on a determination that the multiple SL carriers are available, a channel busy ratio (CBR), and select a SL carrier from the multiple SL carriers for the SL transmission when the measured CBR is less than the first threshold and the received RSRP is greater than the second threshold.

In another embodiment, a method of a UE in a wireless communication system is provided. The method comprises: receiving, from a peer UE, an RSRP; identifying information including a first threshold and a second threshold for a sidelink (SL) transmission; determining whether multiple SL carriers are available for the SL transmission; measuring, based on a determination that the multiple SL carriers are available, a CBR; and selecting a SL carrier from the multiple SL carriers for the SL transmission when the measured CBR is less than the first threshold and the received RSRP is greater than the second threshold.

In yet another embodiment, a BS in a wireless communication system is provided. The BS comprises a processor configured to generate information including a first threshold and a second threshold. The BS further comprises a transceiver operably coupled to the processor, the transceiver configured to transmit, to a UE, the information for an SL transmission that is performed over an SL carrier of multiple SL carriers, wherein a CBR is measured, by the UE, based on an availability of the multiple SL carriers for the SL transmission, and wherein the SL carrier is selected from the multiple SL carriers when the measured CBR is less than the first threshold and an RSRP that is received from a peer UE is greater than the second threshold.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example of wireless network according to embodiments of the present disclosure;

FIG. 2 illustrates an example of gNB according to embodiments of the present disclosure;

FIG. 3 illustrates an example of UE according to embodiments of the present disclosure;

FIGS. 4 and 5 illustrate example of wireless transmit and receive paths according to this disclosure;

FIG. 6 illustrates an example of V2X communication over SL according to embodiments of the present disclosure;

FIG. 7 illustrates an example of SL control and user planes radio protocol stack;

FIG. 8 illustrates a signaling flow for the enhanced (re)selection of candidate carriers for transmission in SL CA according to embodiments of the present disclosure;

FIG. 9 illustrates a flowchart of a UE procedures for the enhanced (re)selection of candidate carriers for transmission in SL CA according to embodiments of the present disclosure;

FIG. 10 illustrates a signaling flow for the enhanced (re)selection of candidate carriers for transmission in SL CA according to embodiments of the present disclosure;

FIG. 11 illustrates a flowchart of a UE procedures for the enhanced (re)selection of candidate carriers for transmission in SL CA according to embodiments of the present disclosure;

FIG. 12A illustrates an example of inter-UE coordination request MAC CE according to embodiments of the present disclosure;

FIG. 12B illustrates an example of inter-UE coordination information MAC CE according to embodiments of the present disclosure;

FIG. 13 illustrates a signaling flows of SL CA operation according to embodiments of the present disclosure; and

FIG. 14 illustrates a flowchart of a method for a (re)selection of candidate carriers for transmission in SL CA according to embodiments of the present disclosure.

### DETAILED DESCRIPTION

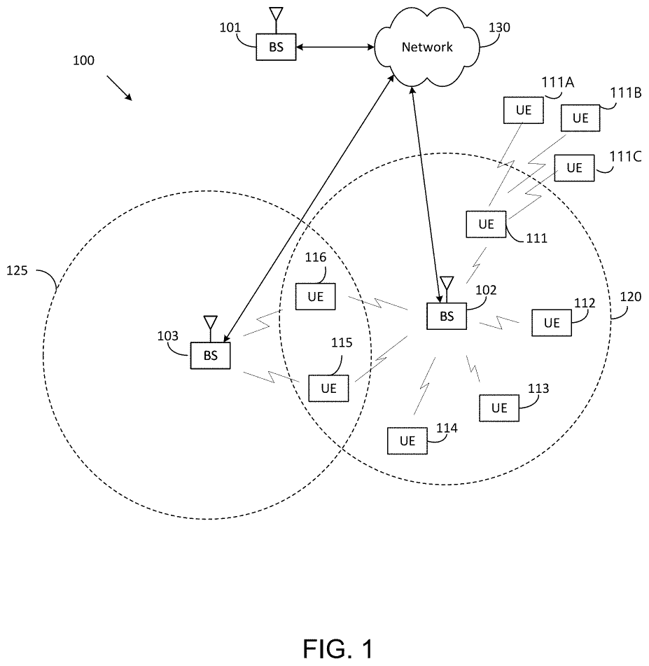

FIG. 1 through FIG. 14, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The following documents are hereby incorporated by reference into the present disclosure as if fully set forth herein: 3GPP TS 38.211 v16.7.0, “NR; Physical channels and modulation”; 3GPP TS 38.212 v16.7.0, “NR; Multiplexing and Channel coding”; 3GPP TS 38.213 v16.7.0, “NR; Physical Layer Procedures for Control”; 3GPP TS 38.214 v16.7.0, “NR; Physical Layer Procedures for Data”; 3GPP TS 38.321 v16.6.0, “NR; Medium Access Control (MAC) protocol specification”; 3GPP TS 38.331 v16.6.0, “NR; Radio Resource Control (RRC) Protocol Specification;” 3GPP TR 38.885, “Study on NR Vehicle-to-Everything (V2X)”; and 3GPP TS 23.287, “Architecture enhancements for 5G System (5GS) to support Vehicle-to-Everything (V2X) services.”

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

In another example, the UE 116 may be within network coverage and the other UE may be outside network coverage (e.g., UEs 111A-111C). In yet another example, both UE are outside network coverage. In some embodiments, one or more of the gNBs 101-103 may communicate with each other and with the UEs 111-116 using 5G/NR, LTE, LTE-A, WiMAX, WiFi, or other wireless communication techniques. In some embodiments, the UEs 111-116 may use a device to device (D2D) interface called PC5 (e.g., also known as sidelink at the physical layer) for communication.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3rd generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for a (re)selection of candidate carriers for transmission in SL CA in a wireless communication system. In certain embodiments, and one or more of the gNBs 101-103 includes circuitry, programing, or a combination thereof, for a (re)selection of candidate carriers for transmission in SL CA in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

As discussed in greater detail below, the wireless network 100 may have communications facilitated via one or more devices (e.g., UEs 111A to 111C) that may have a SL communication with the UE 111. The UE 111 can communicate directly with the UEs 111A to 111C through a set of SLs (e.g., SL interfaces) to provide sideline communication, for example, in situations where the UEs 111A to 111C are remotely located or otherwise in need of facilitation for network access connections (e.g., BS 102) beyond or in addition to traditional fronthaul and/or backhaul connections/interfaces. In one example, the UE 111 can have direct communication, through the SL communication, with UEs 111A to 111C with or without support by the BS 102. Various of the UEs (e.g., as depicted by UEs 112 to 116) may be capable of one or more communication with their other UEs (such as UEs 111A to 111C as for UE 111).

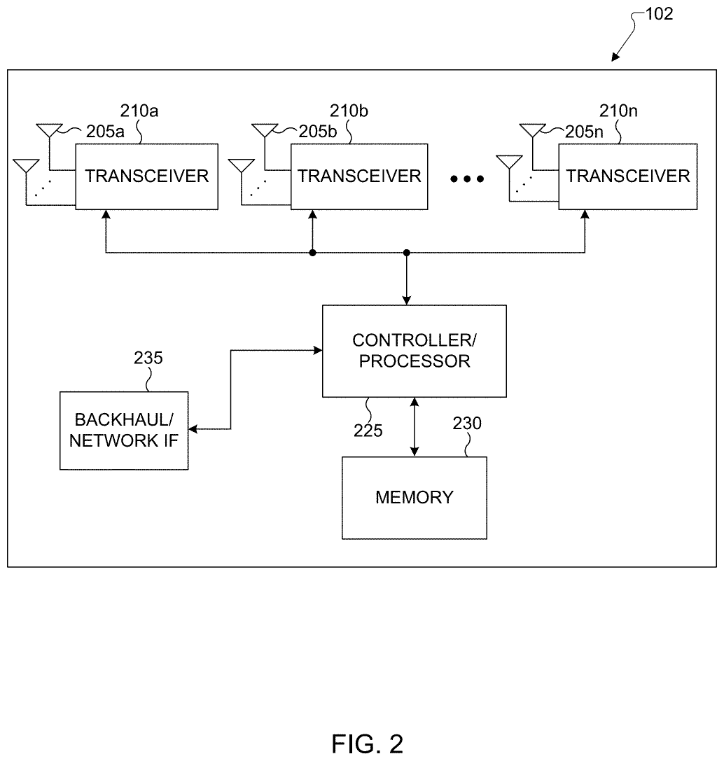

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as an OS. The controller/processor 225 can move data into or out of the memory 230 as required by an executing process. The controller/processor 225 is also capable of executing programs and other processes resident in the memory 230, such as processes, for example, a (re)selection of candidate carriers for transmission in SL CA in a wireless communication system.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

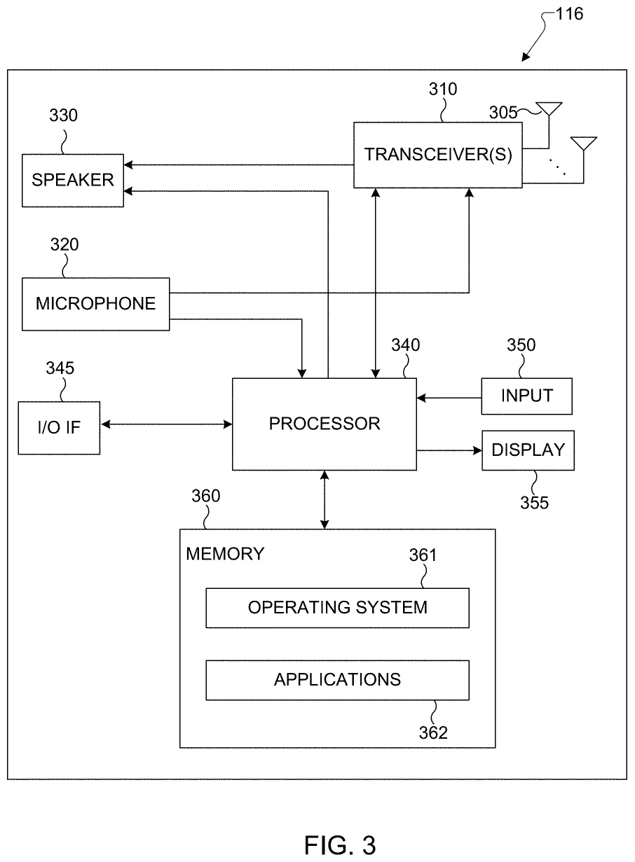

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives, from the antenna 305, an incoming RF signal transmitted by a gNB of the network 100 or by other UEs (e.g., one or more of UEs 111-115) on a SL channel. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL and/or SL channels and/or signals and the transmission of UL and/or SL channels and/or signals by the transceiver(s) 310 in accordance with well-known principles. In some embodiments, the processor 340 includes at least one microprocessor or microcontroller.

The processor 340 is also capable of executing other processes and programs resident in the memory 360, such as processes for a (re)selection of candidate carriers for transmission in SL CA in a wireless communication system. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

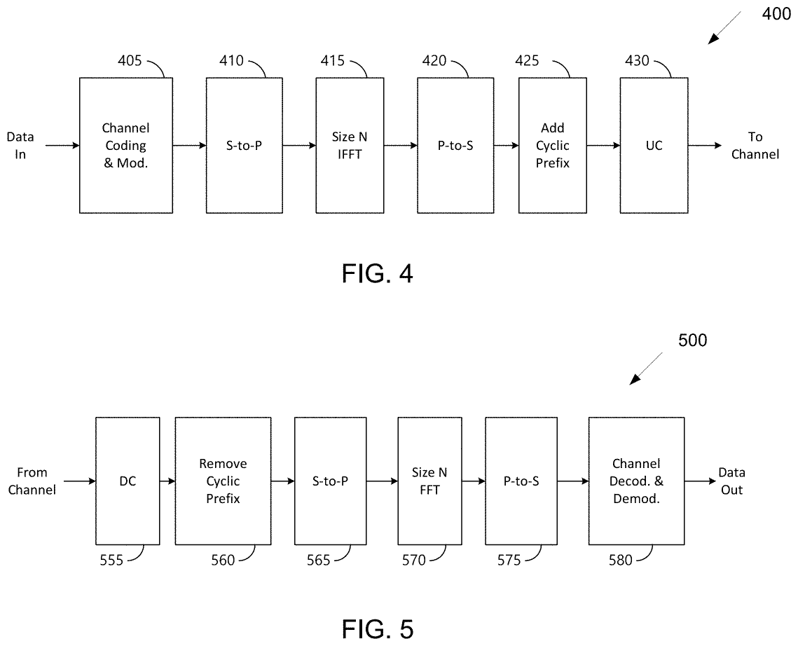

FIG. 4 and FIG. 5 illustrate example wireless transmit and receive paths according to this disclosure. In the following description, a transmit path 400 may be described as being implemented in a gNB (such as the gNB 102), while a receive path 500 may be described as being implemented in a UE (such as a UE 116). However, it may be understood that the receive path 500 can be implemented in a gNB and that the transmit path 400 can be implemented in a UE. It may also be understood that the receive path 500 can be implemented in a first UE and that the transmit path 400 can be implemented in a second UE to support SL communications. In some embodiments, the receive path 500 is configured to support the codebook design and structure for systems having 2D antenna arrays as described in embodiments of the present disclosure.

The transmit path 400 as illustrated in FIG. 4 includes a channel coding and modulation block 405, a serial-to-parallel (S-to-P) block 410, a size N inverse fast Fourier transform (IFFT) block 415, a parallel-to-serial (P-to-S) block 420, an add cyclic prefix block 425, and an up-converter (UC) 430. The receive path 500 as illustrated in FIG. 5 includes a down-converter (DC) 555, a remove cyclic prefix block 560, a serial-to-parallel (S-to-P) block 565, a size N fast Fourier transform (FFT) block 570, a parallel-to-serial (P-to-S) block 575, and a channel decoding and demodulation block 580.

As illustrated in FIG. 4, the channel coding and modulation block 405 receives a set of information bits, applies coding (such as a low-density parity check (LDPC) coding), and modulates the input bits (such as with quadrature phase shift keying (QPSK) or quadrature amplitude modulation (QAM)) to generate a sequence of frequency-domain modulation symbols.

The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116. A transmitted RF signal from a first UE arrives at a second UE after passing through the wireless channel, and reverse operations to those at the first UE are performed at the second UE.

As illustrated in FIG. 5, the downconverter 555 down-converts the received signal to a baseband frequency, and the remove cyclic prefix block 560 removes the cyclic prefix to generate a serial time-domain baseband signal. The serial-to-parallel block 565 converts the time-domain baseband signal to parallel time domain signals. The size N FFT block 570 performs an FFT algorithm to generate N parallel frequency-domain signals. The parallel-to-serial block 575 converts the parallel frequency-domain signals to a sequence of modulated data symbols. The channel decoding and demodulation block 580 demodulates and decodes the modulated symbols to recover the original input data stream.

Each of the gNBs 101-103 may implement a transmit path 400 as illustrated in FIG. 4 that is analogous to transmitting in the downlink to UEs 111-116 and may implement a receive path 500 as illustrated in FIG. 5 that is analogous to receiving in the uplink from UEs 111-116. Similarly, each of UEs 111-116 may implement the transmit path 400 for transmitting in the uplink to the gNBs 101-103 and/or transmitting in the sidelink to another UE and may implement the receive path 500 for receiving in the downlink from the gNBs 101-103 and/or receiving in the sidelink from another UE.

Each of the components in FIG. 4 and FIG. 5 can be implemented using only hardware or using a combination of hardware and software/firmware. As a particular example, at least some of the components in FIG. 4 and FIG. 5 may be implemented in software, while other components may be implemented by configurable hardware or a mixture of software and configurable hardware. For instance, the FFT block 570 and the IFFT block 515 may be implemented as configurable software algorithms, where the value of size N may be modified according to the implementation.

Furthermore, although described as using FFT and IFFT, this is by way of illustration only and may not be construed to limit the scope of this disclosure. Other types of transforms, such as discrete Fourier transform (DFT) and inverse discrete Fourier transform (IDFT) functions, can be used. It may be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIG. 4 and FIG. 5 illustrate examples of wireless transmit and receive paths, various changes may be made to FIG. 4 and FIG. 5. For example, various components in FIG. 4 and FIG. 5 can be combined, further subdivided, or omitted and additional components can be added according to particular needs. Also, FIG. 4 and FIG. 5 are meant to illustrate examples of the types of transmit and receive paths that can be used in a wireless network. Any other suitable architectures can be used to support wireless communications in a wireless network.

In 3GPP wireless standards, new radio access technology (NR) has been specified as 5G wireless communication. One of NR features is vehicle-to-everything (V2X).

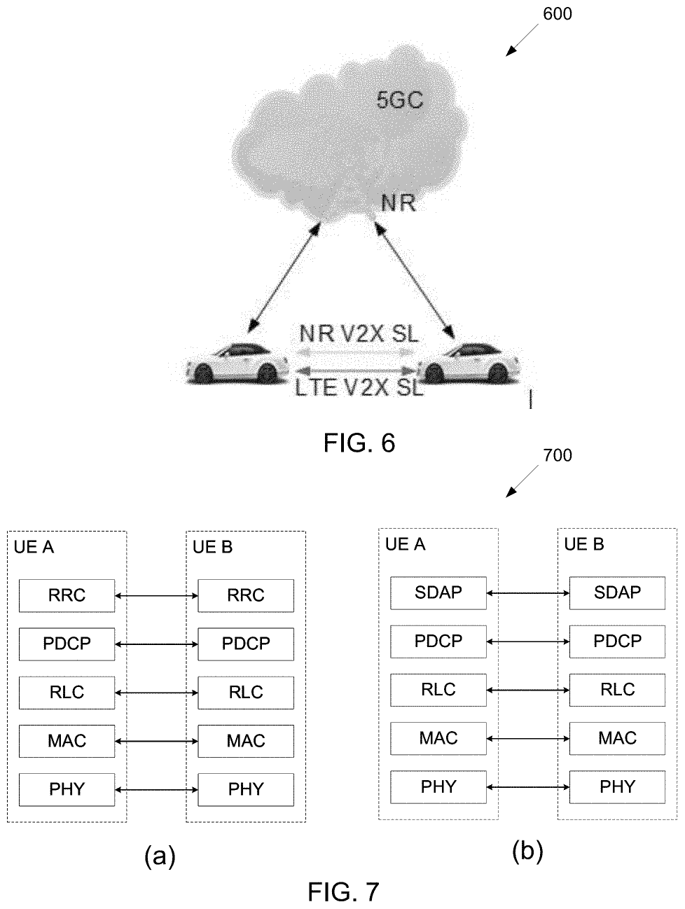

FIG. 6 illustrates an example of V2X communication over SL 600 according to embodiments of the present disclosure. An embodiment of the V2X communication over SL 600 shown in FIG. 6 is for illustration only

FIG. 6 describes the example scenario of vehicle to vehicle communication. Two or multiple vehicles can transmit and receive data/control over direct link/interface between vehicles. The direct link/interface between vehicles or between vehicle and other things is named as SL in 3GPP, so “SL communication” is also commonly used instead of “V2X communication.”

Note that FIG. 6 describes the scenario where the vehicles still can communicate with gNB in order to acquire SL resource, SL radio bearer configurations, etc., however it is also possible even without interaction with gNB, vehicles still communicate each other over SL. In the case, SL resource, SL radio bearer configuration, etc. are preconfigured (e.g., via V2X server or any other core network entity).

One of main difference compared to an uplink (UL) that is a link from the UE to the gNB is the resource allocation mechanism for transmission. In UL, the resource for transmission is allocated by the gNB, however in SL, the UE itself selects a resource within the SL resource pool, which is configured by the gNB and selected by the UE if multiple SL resource pools are configured, based on UE's channel sensing result and the required amount of resources for data/control transmission.

For SL communication, the radio interface L1/L2/L3 (Layer 1/Layer 2/Layer 3) protocols consist of physical protocol (PHY), which specified in 3GPP standards TS 38.211, 38.212, 38.213, 38.214, and 38.215), medium access control (MAC), which specified in 3GPP standards TS 38.321), radio link control (RLC), which specified in 3GPP standards TS 38.322), packet data convergence protocol (PDCP), which specified in 3GPP standards TS 38.323), radio resource control (RRC), which specified in 3GPP standards TS 38.331, and service data adaptation protocol (SDAP), which specified in 3GPP standards TS 37.324).

FIG. 7 illustrates an example of SL control and user planes radio protocol stack 700 according to embodiments of the present disclosure. An embodiment of the SL control and user planes radio protocol stack 700 shown in FIG. 7 is for illustration only

FIG. 7 describes the example of SL control plane radio protocol stack (for SL-RRC) (e.g., (a) of FIG. 7) and SL user plane data radio protocol stack for NR SL communication (e.g., (b) of FIG. 7).

Physical protocol layer handles physical layer signals/channels and physical layer procedures (e.g., physical layer channel structure, physical layer signal encoding/decoding, SL power control procedure, SL cannel status information (CSI) related procedure).

Main physical SL channels and signals are defined as follow: (1) physical sidelink control channel (PSCCH) indicates resource and other transmission parameters used by a UE for PSSCH; (2) physical sidelink shared channel (PSSCH) transmits the TBs of data themselves and CSI feedback information, etc.; (3) physical sidelink feedback channel (PSFCH) transmits HARQ feedback over the sidelink from a UE which is an intended recipient of a PSSCH transmission to the UE which performed the transmission; (4) sidelink synchronization signal includes sidelink primary and sidelink secondary synchronization signals (S-PSS, S-SSS); and (5) physical sidelink broadcast channel (PSBCH) indicates the required essential system information for SL operations.

MAC protocol layer performs packet filtering (e.g., determine whether the received packet is actually destined to the UE (based on the L2 source and destination ids in the MAC header), SL carrier/resource pool/resource within the resource pool (re)selection, priority handling between SL and UL for a given UE, SL logical channel prioritization, the corresponding packet multiplexing (e.g., multiplexing multiple MAC SDUs into a given MAC PDU) and SL HARQ retransmissions/receptions. RLC protocol layer performs RLC SDU segmentation/SDU reassembly, re-segmentation of RLC SDU segments, error correction through ARQ (only for AM data transfer).

PDCP protocol layer performs header compression/decompression, ciphering and/or integrity protection, duplication detection, re-ordering and in-order packet delivery to the upper layer and out-of-order packet delivery to the upper layer. RRC protocol layer performs transfer of a SL-RRC message, which is also named as PC5-RRC (PC5 indicates the reference point between UEs for SL communication), between peer UEs, maintenance and release of SL-RRC connection between two UEs, and detection of SL radio link failure for a SL-RRC connection. SDAP protocol layer performs mapping between a QoS (Quality of Service) flow and a SL data radio bearer. Note that the term of SL-RRC or PC5-RRC is used in the present disclosure.

In 3GPP Rel-18, it is planned to introduce more enhanced features into SL communication and one of the candidate features is to enable Carrier Aggregation (CA) in SL communication. CA is a mechanism to transmit and/or receive control/data over multiple carriers. In UL CA, the serving gNB configures the candidate carriers for CA operation, however since the UE can select the resources by itself in SL communication (resource allocation mode 2), the UE may be able to (re)select the candidate carriers for SL CA operation. This disclosure provides methods and apparatus for enhanced (re)selection of candidate carriers for the transmission in SL CA operation.

In LTE, for the (re)selection of candidate carriers for the transmission in V2X CA operation, the eNB configures the following parameters as shown in 3GPP standard specification. Note that they can be also preconfigured without the eNB involvement for the UE in out-of-coverage (OOC).

The IE SL-V2X-FreqSelectionConfigList specifies the configuration information for carrier selection for V2X sidelink communication transmission using UE autonomous resource selection. TABLE 1 shows SL-V2X-FreqSelectionConfigList information element.

TABLE 1
SL-V2X-FreqSelectionConfigList information element

| | |
|---|---|
| -- ASN1START | |
| SL-V2X-FreqSelectionConfigList-r15 ::= | SEQUENCE (SIZE (1 .. 8)) OF SL-V2X- |
| FreqSelectionConfig-r15 | |
| SL-V2X-FreqSelectionConfig-r15 ::= | SEQUENCE { |
| priorityList-r15 | SL-PriorityList-r13, |
| threshCBR-FreqReselection-r15 | SL-CBR-r14 |
| OPTIONAL, -- Need OR | |
| threshCBR-FreqKeeping-r15 | SL-CBR-r14 |
| OPTIONAL -- Need OR | |
| } | |
| -- ASN1STOP | |

TABLE 2 shows SL-V2X-FreqSelectionConfig field descriptions.

TABLE 2
SL-V2X-FreqSelectionConfig field descriptions
SL-V2X-FreqSelectionConfig field descriptions

priorityList
Indicates the list of PPPP(s) which is associated with the configurations in threshCBR-
FreqReselection and in threshCBR-FreqKeeping.
threshCBR-FreqReselection
Indicates the CBR threshold to determine whether the carrier frequency can be (re)selected for the
transmission of V2X sidelink communication.
threshCBR-FreqKeeping
Indicates the CBR threshold to determine whether the UE can keep using the carrier which was
selected for the transmission of V2X sidelink communication.

With the configuration above, the UE behavior for the (re)selection of candidate carriers for transmission in LTE V2X CA operation is defined as follow.

As illustrated in 3GPP standard specification, the MAC entity may consider a channel busy ratio (CBR) of a carrier to be one measured by lower layers if CBR measurement results are available, or the corresponding defaultTxConfigIndex configured by upper layers for the carrier if CBR measurement results are not available as shown in TABLE 3.

```
TABLE 3
If the TX carrier (re-)selection is triggered for a Sidelink process, the MAC entity may:
- if there is no configured sidelink grant on any carrier allowed for the sidelink
logical channel where data is available as indicated by upper layers:
      - for each carrier configured by upper layers associated with the concerned
sidelink logical channel:
      - if the CBR of the carrier is below threshCBR-FreqReselection associated
with the priority of the sidelink logical channel:
        - consider the carrier as a candidate carrier for TX carrier (re-
)selection for the concerned sidelink logical channel.
- else:
      - for each sidelink logical channel, if any, where data is a vailable and that
are allowed on the carrier for which Tx carrier (re-)selection is triggered:
      - if the CBR of the carrier is below threshCBR-FreqReselection associated
with the priority of the sidelink logical channel;
        - select the carrier and the associated pool of resources.
- else:
      - for each carrier configured by upper layers on which the sidelink logical
channel is allowed, if the CBR of the carrier is below threshCBR-FreqReselection associated
with the priority of the sidelink logical channel;
- consider the carrier as a candidate carrier for TX carrier (re-)selection.
The MAC entity may:
- if one or more carriers are considered as the candidate carriers for TX carrier (re-
)selection:
  - for each sidelink logical channel allowed on the carrier where data is available
and Tx carrier (re-)selection is triggered:
    - select one or more carrier(s) and associated pool(s) of resources among the
candidate carriers with increasing order of CBR from the lowest CBR.
NOTE 1: It is left to UE implementation how many carriers to select based on UE
capability.
```

In NR SL communication in contrast to LTE V2X communication, two peer UEs can have dedicated connection via PC5-RRC procedure, which is called as SL UniCast (UC). SL RRC reconfiguration procedure is to modify a PC5-RRC connection, e.g., to establish/modify/release sidelink DRBs, to (re-)configure NR sidelink measurement and reporting, to (re-)configure sidelink CSI reference signal resources and CSI reporting latency bound. The UE may initiate the sidelink RRC reconfiguration procedure for the (re-)configuration of the peer UE to perform NR sidelink measurement and report. The UE may configure the associated peer UE to perform NR sidelink measurement and report on the corresponding PC5-RRC connection in accordance with the NR sidelink measurement configuration for unicast by RRCReconfigurationSidelink message.

The NR sidelink measurement configuration includes the following parameters example for a PC5-RRC connection.

In one example, NR sidelink measurement objects: Object(s) on which the associated peer UE may perform the NR sidelink measurements.

In another example, for NR sidelink measurement, a NR sidelink measurement object indicates the NR sidelink frequency of reference signals to be measured.

In yet another example of NR sidelink reporting configurations: NR sidelink measurement reporting configuration(s) where there can be one or multiple NR sidelink reporting configurations per NR sidelink measurement object. Each NR sidelink reporting configuration consists of the following: (1) reporting criterion: The criterion that triggers the UE to send a NR sidelink measurement report. This can either be periodical or a single event description; (2) RS type: The RS that the UE uses for NR sidelink measurement results. In this release, only DMRS is supported for NR sidelink measurement; and (3) reporting format: The quantities that the UE includes in the measurement report. In this release, only RSRP measurement is supported.

In yet another example, NR sidelink measurement identities: a list of NR sidelink measurement identities where each NR sidelink measurement identity links one NR sidelink measurement object with one NR sidelink reporting configuration. By configuring multiple NR sidelink measurement identities, it is possible to link more than one NR sidelink measurement object to the same NR sidelink reporting configuration, as well as to link more than one NR sidelink reporting configuration to the same NR sidelink measurement object. The NR sidelink measurement identity is also included in the NR sidelink measurement report that triggered the reporting, serving as a reference to the network.

In yet another example of NR sidelink quantity configurations, the NR sidelink quantity configuration defines the NR sidelink measurement filtering configuration used for all event evaluation and related reporting, and for periodical reporting of that NR sidelink measurement. In each configuration, different filter coefficients can be configured for different NR sidelink measurement quantities.

Both UEs of the PC5-RRC connection maintains a NR sidelink measurement object list, a NR sidelink reporting configuration list, and a NR sidelink measurement identities list.

ASN.1 for NR sidelink measurement configuration is defined as shown in TABLE 4. For the detailed UE behavior on each configuration is defined in 3GPP standard specification.

TABLE 4
ASN.1 for NR sidelink measurement configuration

```
SL-MeasConfig-r16 :=  SEQUENCE {
  sl-MeasObjectToRemoveList-r16 SL-MeasObjectToRemoveList-r16 OPTIONAL, --
Need N
  sl-MeasObjectToAddModList-r16 SL-MeasObjectList-r16 OPTIONAL, -- Need N
  sl-ReportConfigToRemoveList-r16 SL-ReportConfigToRemoveList-r16 OPTIONAL, -
- Need N
  sl-ReportConfigToAddModList-r16 SL-ReportConfigList-r16 OPTIONAL, -- Need N
  sl-MeasIdToRemoveList-r16 SL-MeasIdToRemoveList-r16 OPTIONAL, -- Need N
  sl-MeasIdToAddModList-r16 SL-MeasIdList-r16 OPTIONAL, -- Need N
  sl-QuantityConfig-r16 SL-QuantityConfig-r16 OPTIONAL, -- Need M
  ...
}
```

The IE SL-MeasObjectList concerns a list of SL measurement objects to add or modify for a destination as shown in TABLE 5.

TABLE 5
SL-MeasObjectList information element

```
-- ASN1START
-- TAG-SL-MEASOBJECTLIST-START
SL-MeasObjectList-r16 ::= SEQUENCE (SIZE (1..maxNrofSL-ObjectId-r16)) OF SL-
MeasObjectInfo-r16
SL-MeasObjectInfo-r16 ::=  SEQUENCE {
  sl-MeasObjectId-r16 SL-MeasObjectId-r16,
  sl-MeasObject-r16 SL-MeasObject-r16,
  ...
}
SL-MeasObjectId-r16 ::= INTEGER (1..maxNrofSL-ObjectId-r16)
SL-MeasObject-r16 ::= SEQUENCE {
  frequency InfoSL-r16 ARFCN-ValueNR,
  ...
}
-- TAG-SL-MEASOBJECTLIST-STOP
ASN1 STOP
```

The IE SL-ReportConfigList concerns a list of SL measurement reporting configurations to add or modify for a destination as shown in TABLE 6.

TABLE 6
SL-ReportConfigList information element

```
-- ASN1START
-- TAG-SL-REPORTCONFIGLIST-START
SL-ReportConfigList-r16 ::= SEQUENCE (SIZE (1..maxNrofSL-ReportConfigId-r16)) OF
SL-ReportConfigInfo-r16
SL-ReportConfigInfo-r16 := SEQUENCE {
  sl-ReportConfigId-r16 SL-ReportConfigId-r16,
  sl-ReportConfig-r16 SL-ReportConfig-r16,
  ...
}
SL-ReportConfigId-r16 ::=  INTEGER (1..maxNrofSL-ReportConfigId-r16)
SL-ReportConfig-r16 ::= SEQUENCE {
  sl-ReportType-r16 CHOICE {
    sl-Periodical-r16 SL-PeriodicalReportConfig-r16,
    sl-EventTriggered-r16 SL-EventTriggerConfig-r16,
    ...
  },
  ...
}
SL-PeriodicalReportConfig-r16 ::= SEQUENCE {
  sl-ReportInterval-r16 ReportInterval,
  sl-ReportAmount-r16 ENUMERATED {r1, r2, r4, r8, r16, r32, r64, infinity},
  sl-ReportQuantity-r16 SL-MeasReportQuantity-r16,
  sl-RS-Type-r16 SL-RS-Type-r16,
  ...
}
SL-EventTriggerConfig-r16 ::= SEQUENCE {
  sl-EventId-r16 CHOICE {
  eventS1-r16 SEQUENCE {
    s1-Threshold-r16 SL-MeasTriggerQuantity-r16,
    sl-ReportOnLeave-r16 BOOLEAN,
    sl-Hysteresis-r16 Hysteresis,
    sl-TimeToTrigger-r16 TimeToTrigger,
  ...
  },
  eventS2-r16 SEQUENCE {
    s2-Threshold-r16 SL-MeasTriggerQuantity-r16,
    sl-ReportOnLeave-r16 BOOLEAN,
    sl-Hysteresis-r16 Hysteresis,
    sl-TimeToTrigger-r16 TimeToTrigger,
    ...
    },
  ...
},
  sl-ReportInterval-r16 ReportInterval,
  sl-ReportAmount-r16 ENUMERATED {r1, r2, r4, r8, r16, r32, r64, infinity},
  sl-ReportQuantity-r16 SL-MeasReportQuantity-r16,
  sl-RS-Type-r16 SL-RS-Type-r16,
  ...
}
SL-MeasReportQuantity-r16 ::= CHOICE {
  sl-RSRP-r16 BOOLEAN,
  ...
}
SL-MeasTriggerQuantity-r16 := CHOICE {
sl-RSRP-r16 RSRP-Range,
...
}
SL-RS-Type-r16 ::= ENUMERATED {dmrs, spare3, spare2, spare1}
-- TAG-SL-REPORTCONFIGLIST-STOP
-- ASN1STOP
```

The IE SL-MeasIdList concerns a list of SL measurement identities to add or modify for a destination, with for each entry the sl-MeasId, the associated sl-MeasObjectId and the associated sl-ReportConfigId, as shown in TABLE 7.

TABLE 7
SL-MeasIdList information element

```
-- ASN1START
-- TAG-SL-MEASIDLIST-START
SL-MeasIdList-r16 ::= SEQUENCE (SIZE (1..maxNrofSL-MeasId-r16)) OF SL-MeasIdInfo-
r16
SL-MeasIdInfo-r16 ::=  SEQUENCE {
  sl-MeasId-r16 SL-MeasId-r16,
  sl-MeasObjectId-r16 SL-MeasObjectId-r16,
  sl-ReportConfigId-r16 SL-ReportConfigId-r16,
  ...
}
SL-MeasId-r16 ::= INTEGER  (1..maxNrofSL-MeasId-r16)
-- TAG-SL-MEASIDLIST-STOP
-- ASN1STOP
```

The IE SL-QuantityConfig specifies the layer 3 filtering coefficients for NR SL RSRP measurement for a destination.

TABLE 8
SL-QuantityConfig information element

```
-- ASN1START
-- TAG-SL-QUANTITYCONFIG-START
SL-QuantityConfig-r16 := SEQUENCE {
  sl-FilterCoefficientDMRS-r16 FilterCoefficient DEFAULT fc4,
  ...
}
-- TAG-SL-QuantityConfig-STOP
-- ASN1STOP
```

Once the SL measurement configuration is configured by SL RRC reconfiguration procedure, the corresponding peer UE performs SL measurements based on SL DMRS of SL UC destination and the UE transfers SL measured results to the UE who configured SL measurement configuration via PC5-RRC MeasurementReportSidelink message. SL measured results includes measured SL RSRP value. ASN.1 for MeasurementReportSidelink is defined as follow.

The MeasurementReportSidelink message is used for the indication of measurement results of NR sidelink as shown in TABLE 9 and TABLE 10.

TABLE 9
MeasurementReportSidelink message

Signalling radio bearer: SL-SRB3
RLC-SAP: AM
Logical channel: SCCH
Direction: UE to UE

TABLE 10
MeasurementReportSidelink message

```
-- ASN1START
-- TAG-MEASUREMENTREPORTSIDELINK-START
MeasurementReportSidelink ::=  SEQUENCE {
  criticalExtensions CHOICE {
    measurementReportSidelink-r16  MeasurementReportSidelink-IEs-r16,
    criticalExtensionsFuture SEQUENCE { }
  }
}
MeasurementReportSidelink-IEs-r16 ::=  SEQUENCE {
  sl-measResults-r16 SL-MeasResults-r16,
  late NonCriticalExtension OCTET STRING OPTIONAL,
  nonCriticalExtension SEQUENCE{ } OPTIONAL
}
SL-MeasResults-r16 ::= SEQUENCE {
  sl-MeasId-r16 SL-MeasId-r16,
  sl-MeasResult-r16 SL-MeasResult-r16,
  ...
}
SL-MeasResult-r16 := SEQUENCE {
  sl-ResultDMRS-r16 SL-MeasQuantityResult-r16 OPTIONAL,
  ...
}
SL-MeasQuantityResult-r16 ::= SEQUENCE {
  sl-RSRP-r16 RSRP-Range OPTIONAL,
  ...
}
-- TAG-MEASUREMENTREPORTSIDELINK-STOP
-- ASN1STOP
```

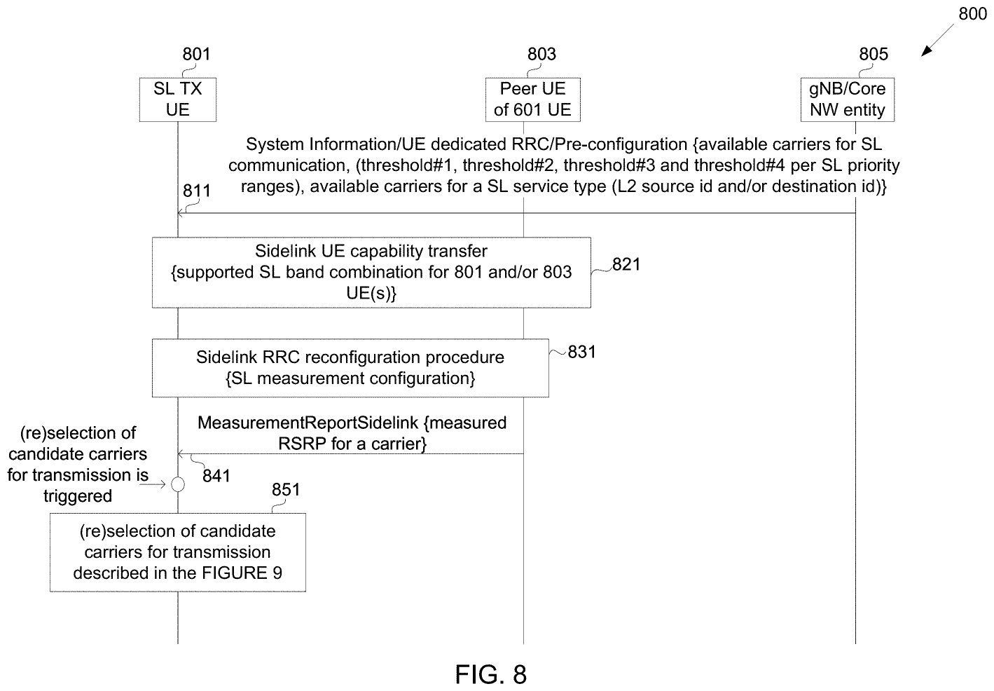

FIG. 8 illustrates a signaling flow 800 for the enhanced (re)selection of candidate carriers for transmission in SL CA according to embodiments of the present disclosure. The signaling flow 800 as may be performed by a UE (e.g., 111-116 as illustrated in FIG. 1) and a BS (e.g., 101-103 as illustrated in FIG. 1). An embodiment of the signaling flow 800 shown in FIG. 8 is for illustration only. One or more of the components illustrated in FIG. 8 can be implemented in specialized circuitry configured to perform the noted functions or one or more of the components can be implemented by one or more processors executing instructions to perform the noted functions.

FIG. 8 describes one example of overall signaling flows for the enhanced (re)selection of candidate carriers for transmission in SL CA. 801 indicates SL TX UE which performs (re)selection of candidate carriers for transmission in SL CA and 803 indicates the peer UE of 801 UE for SL UC communication. 805 indicates either the (serving) gNB of 801 UE or the core NW entity which is responsible to set SL pre-configurations for 801 UE. In 811, information of available carriers for SL communication, thresholds (threshold #1, threshold #2, threshold #3, and threshold #4) per SL priority range, and available carriers for a SL service type (or instead of SL service type, L2 source id and/or L2 destination id, or a pair of L2 source id and destination id) is provided to 801 UE via system information and/or UE dedicated RRC message and/or pre-configuration.

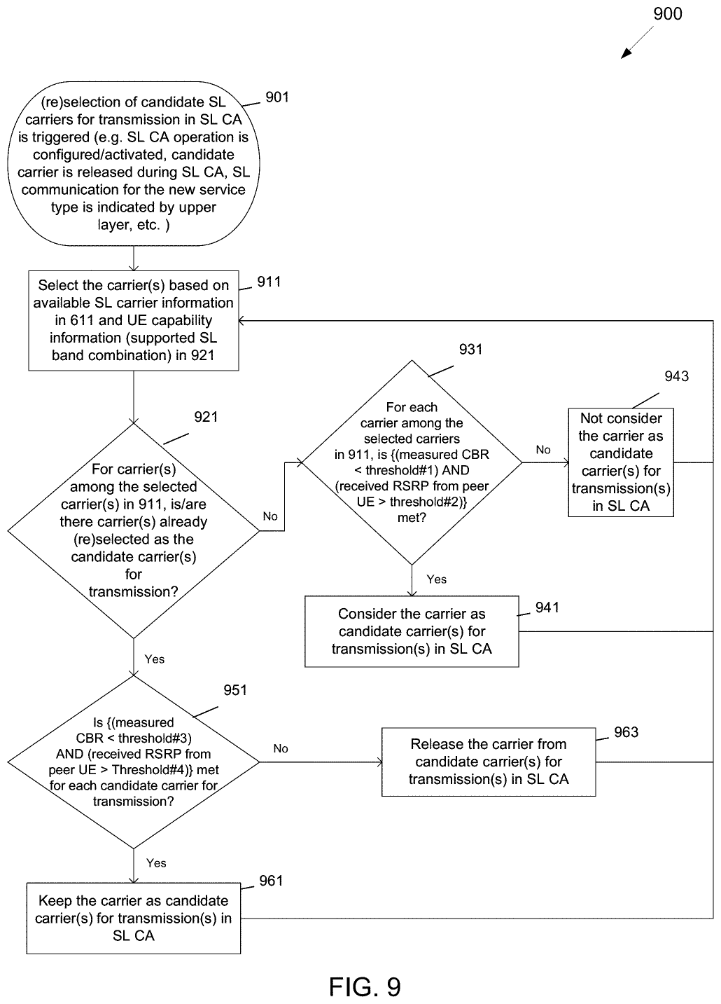

Some information (e.g., available carriers for a SL service type (or instead of SL service type, L2 source id and/or L2 destination id, or a pair of L2 source id and destination id)) may be provided only by pre-configuration. Information of available carriers for SL communication indicates the available carriers for whole SL communication in a given cell or in a given geographical area where 801 UE is served or located. Information of thresholds per SL priority range indicates each threshold value per SL priority range, which are used in the provided (re)selection of candidate carriers for transmission described in FIG. 9.

FIG. 9 illustrates a flowchart of a UE procedures 900 for the enhanced (re)selection of candidate carriers for transmission in SL CA according to embodiments of the present disclosure. The UE procedures 900 as may be performed by a UE (e.g., 111-116 as illustrated in FIG. 1). An embodiment of the UE procedures 900 shown in FIG. 9 is for illustration only. One or more of the components illustrated in FIG. 9 can be implemented in specialized circuitry configured to perform the noted functions or one or more of the components can be implemented by one or more processors executing instructions to perform the noted functions.

Information of available carriers for a SL service type (or instead of SL service type, L2 source id and/or L2 destination id, or a pair of L2 source id and destination id) indicates available carriers that can be used for a specific SL service type (or instead of SL service type, L2 source id and/or L2 destination id, or a pair of L2 source id and destination id). Note information of available carriers for SL communication and available carriers for a SL service type (or instead of SL service type, L2 source id and/or L2 destination id, or a pair of L2 source id and destination id) in which 801 UE is interested in transmission can be different.

821 indicates sidelink UE capability transfer procedure over PC5-RRC. During the sidelink UE capability transfer procedure, the UE 801 and/or the UE 803 informs its peer UE of its supported capability information. The capability information also includes the supported SL band combinations for simultaneous transmission and/or reception. 831 indicates sidelink RRC reconfiguration procedure over PC5-RRC. During the sidelink RRC reconfiguration procedure, SL measurement configuration is configured for the UE 803. 841 indicates the UE 803 performs SL measurement and transfer the measured RSRP according to the SL measurement configuration in 831. If (re)selection of candidate carriers for transmission is triggered, in 851 the UE 801 performs (re)selection of candidate carriers for transmission which will be described in FIG. 9.

FIG. 9 describes one example of UE procedures for the enhanced (re)selection of candidate carriers for transmission in SL CA. In 901, the UE triggers (re)selection of candidate SL carriers for transmission in SL CA. The example triggering conditions are when SL CA operation is configured and/or activated, when the (re)selected candidate carrier(s) is/are released while the UE is in SL CA operation (e.g., as the output of procedure 963), or when the SL communication for the new service type (or instead of new service type, for the new L2 source id and/or L2 destination id, or a pair of L2 source id and destination id) is indicated by the upper layer, etc.

Once (re)selection of candidate SL carriers for transmission in SL CA is triggered, in 911 the UE selects the carrier(s) based on available SL carrier information in 811 and UE capability information (e.g., supported SL band combination) in 821. The UE selects the carriers that can be supported by all of available carriers for SL communication, available carriers for a SL service type (or instead of SL service type, L2 source id and/or L2 destination id, or a pair of L2 source id and destination id), and UE's capability 801 for simultaneous transmissions in SL CA and UE's capability 803 for simultaneous receptions in SL CA. For example, if available carriers for SL communication (signaled via system information/UE dedicated RRC configuration/pre-configuration) indicates carrier #1, carrier #2, carrier #3, carrier #4, and carrier #5, and available carrier for a SL service type in which the UE 801 is interested for transmission (signaled via pre-configuration) indicates carrier #1, carrier #2, carrier #3, and carrier #4, and if carrier #1, carrier #2, and carrier #3 are supported for both simultaneous transmissions by the UE 801 capability and simultaneous receptions by the UE 803 capability, then the UE selects carrier #1, carrier #2, and carrier #3 in 711.

In 921, for carrier(s) among the selected carrier(s) in 911, the UE checks if there is/are carrier(s) already (re)selected as the candidate carrier(s) for transmission as output of 941 and/or 961 in the past. As another example, the UE checks if {(there is/are carrier(s) already (re)selected as the candidate carrier(s) for transmission as output of 941 and/or 961 in the past) AND (for a sidelink logical channel where data is available to be sent if transmission of the data on the already (re)selected candidate carrier(s) is allowed)}.

If the condition in 921 is not met (for example when there is no configured sidelink grant on any carrier allowed for the sidelink logical channel where data is available as indicated by upper layers), in 931 the UE checks if the condition {(measured CBR<threshold #1) AND (the received valid/latest RSRP from the peer UE (e.g., in 841 of FIG. 8)>threshold #2)} is met for each carrier among the selected carriers in 911. If the condition in 931 is met for a carrier, in 941 the UE considers the carrier as candidate carrier(s) for transmission(s) in SL CA. If the condition in 931 is not met for a carrier, in 943 the UE does not consider the carrier as candidate carrier(s) for transmission(s) in SL CA.

In another example, in 931 the UE checks if the condition (measured CBR<threshold #1) OR (the received valid/latest RSRP from the peer UE (e.g., in 841, FIG. 8)>threshold #2) is met for each candidate carrier for transmission in SL CA. This OR condition can work with both threshold #1 and threshold #2. Alternatively, if the gNB or other network entity (e.g., SL/V2X function which is responsible for SL/V2X preconfiguration) configures/preconfigures either the threshold #1 only or threshold #2 only, the UE checks only the condition that is related to the configured/preconfigured threshold. Or the gNB or other network entity (e.g., SL/V2X function which is responsible for SL/V2X preconfiguration) configures/preconfigures separate explicit information indicating whether the measured CBR or the received RSRP from the peer UE is used in the condition.

If the condition in 921 is met, in 951 the UE checks if the condition {(measured CBR<threshold #3) AND (the received valid/latest RSRP from the peer UE (e.g., in 841, FIG. 8)>threshold #4)} is met for each candidate carrier for transmission in SL CA. If the condition in 951 is met, in 961 the UE keeps the carrier as candidate carrier(s) for transmission(s) in SL CA. The UE selects the resource pool and the resource in a carrier among the carriers which the UE decides to keep as candidate carrier(s) for transmission in 961. If the condition in 951 is not met, in 963 the UE releases the carrier from candidate carrier(s) for transmission(s) in SL CA. The UE does not consider the released carrier(s) as the candidate carrier(s) for transmission in SL CA anymore.

In another example, in 951 the UE checks if the condition (measured CBR<threshold #3) OR (the received valid/latest RSRP from the peer UE (e.g., in 841, FIG. 8)>threshold #4) is met for each candidate carrier for transmission in SL CA. This OR condition can work with both threshold #3 and threshold #4. Alternatively, if the gNB or other network entity (e.g., SL/V2X function which is responsible for SL/V2X preconfiguration) configures/preconfigures either the threshold #3 only or threshold #4 only, the UE checks only the condition that is related to the configured/preconfigured threshold. Or the gNB or other network entity (e.g., SL/V2X function which is responsible for SL/V2X preconfiguration) configures/preconfigures separate explicit information indicating whether the measured CBR or the received RSRP from the peer UE is used in the condition.

Note SL RSRP provided by physical layer (before applying layer 3 filtering) is defined as follow. MeasurementReportSidelink includes measured SL RSRP after applying layer 3 filtering. TABLE 11 shows PSBCH reference signal received power (PSBCH-RSRP).

TABLE 11
PSBCH reference signal received power (PSBCH-RSRP)

| | |
|---|---|
| Definition | PSBCH reference signal received power (PSBCH-RSRP) |
| | is defined as the linear average over the power contributions |
| | (in [W]) of the resource elements that carry demodulation |
| | reference signals associated with physical sidelink broadcast |
| | channel (PSBCH). |
| | For PSBCH-RSRP sidelink secondary synchronization |
| | signals in addition to demodulation reference signals |
| | for PSBCH may be used. PSBCH-RSRP using sidelink |
| | secondary synchronization signals may be measured by |
| | linear averaging over the power contributions of the |
| | resource elements that carry corresponding reference signals. |
| | For frequency range 1, the reference point for the |
| | PSBCH RSRP may be the antenna connector of the UE. |
| | For frequency range 2, PSBCH-RSRP may be measured |
| | based on the combined signal from antenna elements |
| | corresponding to a given receiver branch. For frequency |
| | range 1 and 2, if receiver diversity is in use by the |
| | UE, the reported PSBCH-RSRP value may not be lower |
| | than the corresponding PSBCH-RSRP of any of the |
| | individual receiver branches. |
| Applicable | RRC_IDLE intra-frequency, |
| for | RRC_IDLE inter-frequency, |
| | RRC_CONNECTED inter-frequency |

In one example, the number of resource elements within the considered measurement frequency bandwidth and within the measurement period that are used by the UE to determine PSBCH-RSRP is left up to the UE implementation with the limitation that corresponding measurement accuracy requirements have to be fulfilled.

In one example, the power per resource element is determined from the energy received during the useful part of the symbol, excluding the CP.

In one example, it is up to UE implementation to use PSBCH DMRS only or both S-SSS and PSBCH DMRS for PSBCH-RSRP. TABLE 12 shows PSBCH reference signal received power (PSBCH-RSRP).

TABLE 12
PSSCH reference signal received power (PSSCH-RSRP)

| | |
|---|---|
| Definition | PSSCH reference signal received power (PSSCH-RSRP) |
| | is defined as the linear average over the power |
| | contributions (in [W]) of the resource elements of |
| | the antenna port(s) that carry demodulation reference |
| | signals associated with physical sidelink shared |
| | channel (PSSCH), summed over the antenna ports. |
| | Demodulation reference signals transmitted on antenna |
| | ports may be used for PSSCH-RSRP determination if |
| | two antenna ports are indicated. |
| | For frequency range 1, the reference point for the |
| | PSSCH-RSRP may be the antenna connector of the UE. |
| | For frequency range 2, PSSCH-RSRP may be measured |
| | based on the combined signal from antenna elements |
| | corresponding to a given receiver branch. For frequency |
| | range 1 and 2, if receiver diversity is in use by the |
| | UE, the reported PSSCH-RSRP value may not be lower |
| | than the corresponding PSSCH-RSRP of any of the |
| | individual receiver branches. |
| Applicable | RRC_IDLE intra-frequency, |
| for | RRC_IDLE inter-frequency, |
| | RRC_CONNECTED inter-frequency |

In one example, the power per resource element is determined from the energy received during the useful part of the symbol, excluding the CP. TABLE 13 shows PSCCH reference signal received power (PSCCH-RSRP).

TABLE 13
PSCCH reference signal received power (PSCCH-RSRP)

| | |
|---|---|
| Definition | PSCCH reference signal received power (PSCCH-RSRP) |
| | is defined as the linear average over the power |
| | contributions (in [W]) of the resource elements that |
| | carry demodulation reference signals associated with |
| | physical sidelink control channel (PSCCH). |
| | For frequency range 1, the reference point for the |
| | PSCCH-RSRP may be the antenna connector of the UE. |
| | For frequency range 2, PSCCH-RSRP may be measured |
| | based on the combined signal from antenna elements |
| | corresponding to a given receiver branch. For frequency |
| | range 1 and 2, if receiver diversity is in use by the |
| | UE, the reported PSCCH-RSRP value may not be lower |
| | than the corresponding PSCCH-RSRP of any of the |
| | individual receiver branches. |
| Applicable | RRC_IDLE intra-frequency, |
| for | RRC_IDLE inter-frequency, |
| | RRC_CONNECTED inter-frequency |

In one example, the power per resource element is determined from the energy received during the useful part of the symbol, excluding the CP.

Note that SL CBR provided by physical layer (before applying layer 3 filtering) is defined as follow. MeasurementReportSidelink includes measured SL CBR after applying layer 3 filtering as shown in TABLE 14.

TABLE 14
Sidelink channel busy ratio (SL CBR)

| | |
|---|---|
| Definition | SL Channel Busy Ratio (SL CBR) measured in slot n |
| | is defined as the portion of sub-channels in the |
| | resource pool whose SL RSSI measured by the UE exceed |
| | a (pre-)configured threshold sensed over a CBR |
| | measurement window [n-a, n-1], wherein a is equal |
| | to 100 or 100 · 2^{μ} slots, according to higher layer |
| | parameter sl-TimeWindowSizeCBR. |
| Applicable | RRC_IDLE intra-frequency, |
| for | RRC_IDLE inter-frequency, |
| | RRC_CONNECTED intra-frequency, |
| | RRC_CONNECTED inter-frequency |

In one example, the slot index is based on physical slot index.

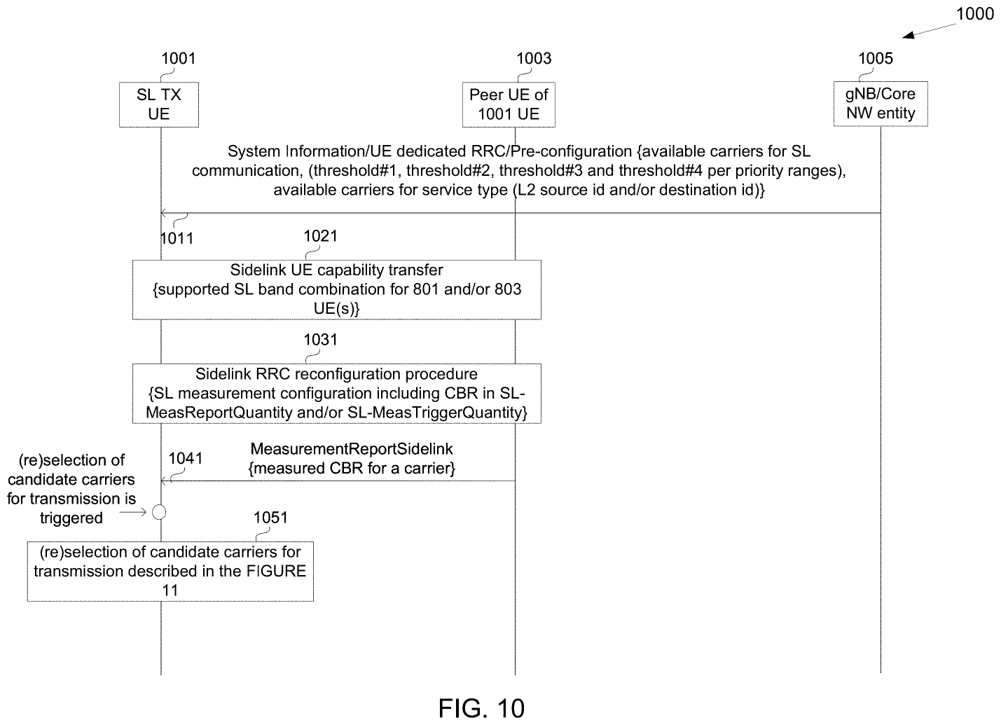

FIG. 10 illustrates a signaling flow 1000 for the enhanced (re)selection of candidate carriers for transmission in SL CA according to embodiments of the present disclosure. The signaling flow 1000 as may be performed by a UE (e.g., 111-116 as illustrated in FIG. 1) and a BS (e.g., 101-103 as illustrated in FIG. 1). An embodiment of the signaling flow 1000 shown in FIG. 10 is for illustration only. One or more of the components illustrated in FIG. 10 can be implemented in specialized circuitry configured to perform the noted functions or one or more of the components can be implemented by one or more processors executing instructions to perform the noted functions.

FIG. 10 describes another example of overall signaling flows for the enhanced (re)selection of candidate carriers for transmission in SL CA. 1001 indicates SL TX UE which performs (re)selection of candidate carriers for transmission in SL CA and 1003 indicates the peer UE of UE 1001 for SL UC communication. 1005 indicates either the (serving) gNB of UE 1001 or the core NW entity which is responsible to set SL pre-configurations for the UE 1001. In 1011, information of available carriers for SL communication, thresholds (threshold #1, threshold #2, threshold #3, and threshold #4) per SL priority range, and available carriers for a SL service type (or instead of SL service type, L2 source id and/or L2 destination id, or a pair of L2 source id and destination id) is provided to the UE 1001 via system information and/or UE dedicated RRC message and/or pre-configuration.

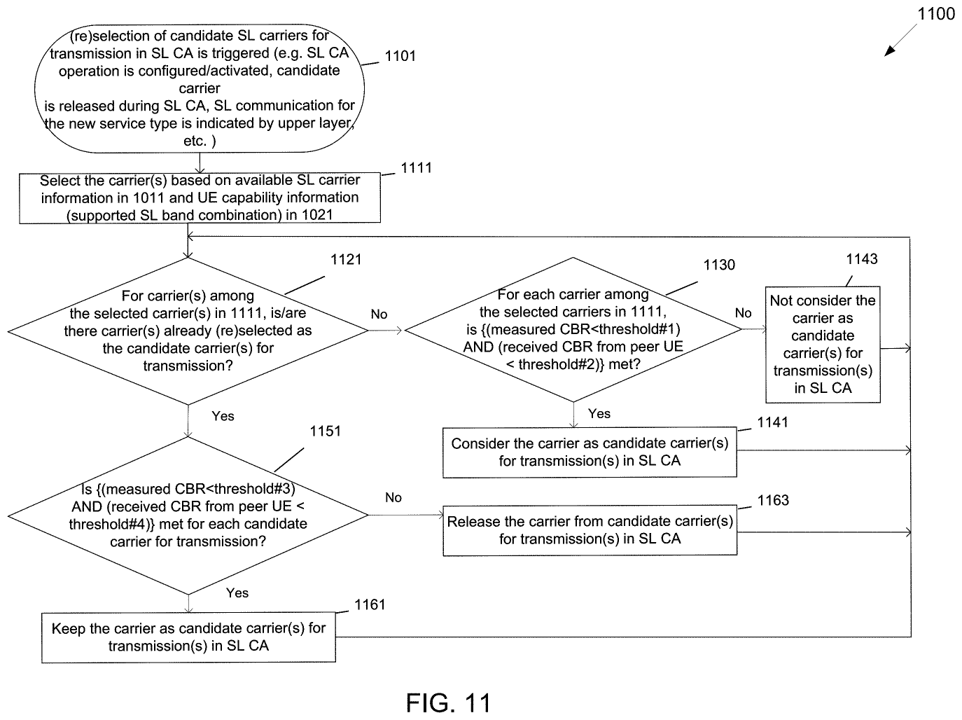

Some information (e.g., available carriers for a SL service type (or instead of SL service type, L2 source id and/or L2 destination id, or a pair of L2 source id and destination id)) may be provided only by pre-configuration. Information of available carriers for SL communication indicates the available carriers for whole SL communication in a given cell or in a given geographical area where 1001 UE is served or located. Information of thresholds per SL priority range indicates each threshold value per SL priority range, which are used in the provided (re)selection of candidate carriers for transmission described in FIG. 11.

Information of available carriers for a SL service type (or instead of SL service type, L2 source id and/or L2 destination id, or a pair of L2 source id and destination id) indicates available carriers that can be used for a specific SL service type (or instead of SL service type, L2 source id and/or L2 destination id, or a pair of L2 source id and destination id). Note information of available carriers for SL communication and available carriers for a SL service type (or instead of SL service type, L2 source id and/or L2 destination id, or a pair of L2 source id and destination id) in which the UE 1001 is interested in a transmission can be different. 1021 indicates sidelink UE capability transfer procedure over PC5-RRC.

During the sidelink UE capability transfer procedure, the UE 1001 and/or the UE 1003 informs its peer UE of its supported capability information. The capability information also includes the supported SL band combinations for simultaneous transmission and/or reception. 1031 indicates sidelink RRC reconfiguration procedure over PC5-RRC. During the sidelink RRC reconfiguration procedure, SL measurement configuration is configured for the UE 1003.

In 1031, new configuration (measured CBR) can be included in the SL measurement reporting quantity (SL-MeasReportQuantity) and/or new configuration (CBR measurement) can be included in the SL measurement report triggering quantity (SL-MeasTriggerQuantity). It means the UE 1003 includes measured CBR in MeasurementReportSidelink for a carrier if measured CBR is configured in SL-MeasReportQuantity and/or the UE 1003 triggers transmission of MeasurementReportSidelink for a carrier if CBR measurement is configured in SL-MeasTriggerQuantity and a SL measurement reporting event is met based on CBR measurement. 1041 indicates the UE 1003 performs SL measurement and transfer the measured CBR according to the SL measurement configuration in 1031. If (re)selection of candidate carriers for transmission is triggered, in 1051, the UE 1001 performs (re)selection of candidate carriers for transmission which will be described in FIG. 11.

FIG. 11 illustrates a flowchart of a UE procedures 1100 for the enhanced (re)selection of candidate carriers for transmission in SL CA according to embodiments of the present disclosure. The UE procedures 1100 as may be performed by a UE (e.g., 111-116 as illustrated in FIG. 1). An embodiment of the UE procedures 1100 shown in FIG. 11 is for illustration only. One or more of the components illustrated in FIG. 11 can be implemented in specialized circuitry configured to perform the noted functions or one or more of the components can be implemented by one or more processors executing instructions to perform the noted functions.

FIG. 11 describes another example of UE procedures for the enhanced (re)selection of candidate carriers for transmission in SL CA. In 1101, the UE triggers (re)selection of candidate SL carriers for transmission in SL CA. The example triggering conditions are when SL CA operation is configured and/or activated, when the (re)selected candidate carrier(s) is/are released while the UE is in SL CA operation (e.g., as the output of procedure 1163), or when the SL communication for the new service type (or instead of new service type, for the new L2 source id and/or L2 destination id, or a pair of L2 source id and destination id) is indicated by the upper layer, etc.

Once (re)selection of candidate SL carriers for transmission in SL CA is triggered, in 1111, the UE selects the carrier(s) based on available SL carrier information in 1011 and UE capability information (e.g., supported SL band combination) in 1021. The UE selects the carriers that can be supported by all of available carriers for SL communication, available carriers for a SL service type (or instead of SL service type, L2 source id and/or L2 destination id, or a pair of L2 source id and destination id), and UE's capability 1001 for simultaneous transmissions in SL CA and UE's capability 1003 for simultaneous receptions in SL CA.

For example, if available carriers for SL communication (signaled via system information/UE dedicated RRC configuration/pre-configuration) indicates carrier #1, carrier #2, carrier #3, carrier #4, and carrier #5, and available carrier for a SL service type in which 801 UE is interested for transmission (signaled via pre-configuration) indicates carrier #1, carrier #2, carrier #3, and carrier #4, and if carrier #1, carrier #2 and carrier #3 are supported for both simultaneous transmissions by the UE 1001 capability and simultaneous receptions by the UE 1003 capability, then the UE selects carrier #1, carrier #2 and carrier #3 in 1111.

In 1121, for carrier(s) among the selected carrier(s) in 1111, the UE checks if there is/are carrier(s) already (re)selected as the candidate carrier(s) for transmission as output of 1141 and/or 1161 in the past. As another example, the UE checks if {(there is/are carrier(s) already (re)selected as the candidate carrier(s) for transmission as output of 1141 and/or 1161 in the past) AND (for a sidelink logical channel where data is available to be sent if transmission of the data on the already (re)selected candidate carrier(s) is allowed)}.

If the condition in 1121 is not met (for example when there is no configured sidelink grant on any carrier allowed for the sidelink logical channel where data is available as indicated by upper layers), in 1131 the UE checks if the condition {(its own measured CBR<threshold #1) AND (the received valid/latest CBR from the peer UE (e.g., in 1041 of FIG. 10)<threshold #2)} is met for each carrier among the selected carriers in 1111. Note as another example instead of threshold #2, threshold #1 can be also used for the comparison with the received valid/latest CBR from the peer UE.

In the case, network does not need to configure threshold #2 in separate. If the condition in 1131 is met for a carrier, in 1141 the UE considers the carrier as candidate carrier(s) for transmission(s) in SL CA. If the condition in 1131 is not met for a carrier, in 1143 the UE does not consider the carrier as candidate carrier(s) for transmission(s) in SL CA. If the condition in 1121 is met, in 1151 the UE checks if the condition {(its own measured CBR<threshold #3) AND (the received valid/latest CBR from the peer UE (e.g., in 1041 of FIG. 10)<threshold #4)} is met for each candidate carrier for transmission in SL CA. Note as another example instead of threshold #4, threshold #3 can be also used for the comparison with the received valid/latest CBR from the peer UE.

In the case, network does not need to configure threshold #4 in separate. If the condition in 1151 is met, in 1161 the UE keeps the carrier as candidate carrier(s) for transmission(s) in SL CA. The UE selects the resource pool and the resource in a carrier among the carriers which the UE decides to keep as candidate carrier(s) for transmission in 1161. If the condition in 1151 is not met, in 1163 the UE releases the carrier from candidate carrier(s) for transmission(s) in SL CA. The UE does not consider the released carrier(s) as the candidate carrier(s) for transmission in SL CA anymore.

Note that SL CBR provided by physical layer (before applying layer 3 filtering) has the same definition as described earlier and MeasurementReportSidelink includes measured SL CBR after applying layer 3 filtering.

SL control information (SCI) on PSCCH includes two SCI formats. The 1st stage SCI format is SCI format 1-A and the 2nd stage SCI format is SCI format 2-A and/or SCI format 2-B. Each SCI format has the following information.

An SCI format 1-A is used for the scheduling of PSSCH and 2nd-stage-SCI on PSSCH. The following information is transmitted by means of the SCI format 1-A:
Priority—3 bits as defined in 3GPP standard specification;
Frequency resource assignment—

$$⌈ {log}_{2} ( \frac{{N}_{subChannel}^{S L} ( {N}_{s u b C hannel}^{S L} + 1 )}{2} ) ⌉$$

bits when the value of the higher layer parameter sl-MaxNumPerReserve is configured to 2; otherwise

$$⌈ {log}_{2} ( \frac{{N}_{subChannel}^{S L} ( {N}_{subChannel}^{S L} + 1 ) ( 2 {N}_{subChannel}^{S L} + 1 )}{6} ) ⌉$$

bits when the value of the higher layer parameter sl-MaxNumPerReserve is configured to 3, as defined in 3GPP standard specification;
Time resource assignment—5 bits when the value of the higher layer parameter sl-MaxNumPerReserve is configured to 2; otherwise, 9 bits when the value of the higher layer parameter sl-MaxNumPerReserve is configured to 3, as defined in 3GPP standard specification;
Resource reservation period—┌log₂ N_{rsv_period}┐ bits as defined in 3GPP standard specification, where N_{rsv_period} is the number of entries in the higher layer parameter sl-ResourceReservePeriodList, if higher layer parameter sl-MultiReserveResource is configured; 0 bit otherwise;
DMRS pattern—┌log₂ Nₚₐₜₜₑᵣₙ┐ bits as defined in 3GPP standard specification, where Nₚₐₜₜₑᵣₙ is the number of DMRS patterns configured by higher layer parameter sl-PSSCH-DMRS-TimePatternList; 0 bit if sl-PSSCH-DMRS-TimePatternList is not configured;
2nd-stage SCI format—2 bits as defined in 3GPP standard specification;
Beta offset indicator—2 bits as provided by higher layer parameter sl-B etaOffsets2ndSCI as defined in 3GPP standard specification;
Number of DMRS port—1 bit as defined in 3GPP standard specification;
Modulation and coding scheme—5 bits as defined in 3GPP standard specification;
Additional MCS table indicator—as defined in 3GPP standard specification: 1 bit if one MCS table is configured by higher layer parameter sl-Additional-MCS-Table; 2 bits if two MCS tables are configured by higher layer parameter sl-Additional-MCS-Table; 0 bit otherwise;
PSFCH overhead indication—1 bit as defined in 3GPP standard specification if higher layer parameter sl-PSFCH-Period=2 or 4; 0 bit otherwise; and
Reserved—a number of bits as determined by higher layer parameter sl-NumReservedBits, with value set to zero.

TABLE 15
2^{nd}-stage SCI formats

| Value of 2nd-stage | |
|---|---|
| SCI format field | 2nd-stage SCI format |
| 00 | SCI format 2-A |
| 01 | SCI format 2-B |
| 10 | Reserved |
| 11 | Reserved |

TABLE 16
Mapping of Beta_offset indicator values to indexes

| Value of | |
|---|---|
| Beta_offset | |
| indicator | Beta_offset index |
| 00 | 1st index provided by higher layer parameter |
| | sl-BetaOffsets2ndSCI |
| 01 | 2nd index provided by higher layer parameter |
| | sl-BetaOffsets2ndSCI |
| 10 | 3rd index provided by higher layer parameter |
| | sl-BetaOffsets2ndSCI |
| 11 | 4th index provided by higher layer parameter |
| | sl-BetaOffsets2ndSCI |

TABLE 17
Number of DMRS port(s)

| Value of the Number | |
|---|---|
| of DMRS port field | Antenna ports |
| 0 | 1000 |
| 1 | 1000 and 1001 |

An SCI format 2-A is used for the decoding of PSSCH, with HARQ operation when HARQ-ACK information includes ACK or NACK, or when there is no feedback of HARQ-ACK information.

The following information is transmitted by means of the SCI format 2-A:
HARQ process number—┌log₂ N_{process}┐ bits as defined in 3GPP standard specification;
New data indicator—1 bit as defined in 3GPP standard specification;
Redundancy version—2 bits as defined in 3GPP standard specification;
Source ID—8 bits as defined in 3GPP standard specification;
Destination ID—16 bits as defined in 3GPP standard specification;
HARQ feedback enabled/disabled indicator—1 bit as defined in 3GPP standard specification;
Cast type indicator—2 bits as defined in 3GPP standard specification; and
CSI request—1 bit as defined in 3GPP standard specification.

TABLE 18
Cast type indicator

| Value of Cast type indicator | Cast type |
|---|---|
| 00 | Broadcast |
| 01 | Groupcast |
| 10 | Unicast |
| 11 | Reserved |

An SCI format 2-B is used for the decoding of PSSCH, with HARQ operation when HARQ-ACK information includes only NACK, or when there is no feedback of HARQ-ACK information.

The following information is transmitted by means of the SCI format 2-B:
HARQ process number—┌log₂ N_{process}┐ bits as defined in 3GPP standard specification;
New data indicator—1 bit as defined in 3GPP standard specification;
Redundancy version—2 bits as defined in 3GPP standard specification;
Source ID—8 bits as defined in 3GPP standard specification;
Destination ID—16 bits as defined in 3GPP standard specification;
HARQ feedback enabled/disabled indicator—1 bit as defined in 3GPP standard specification;
Zone ID—12 bits as defined in 3GPP standard specification; and
Communication range requirement—4 bits as defined in 3GPP standard specification.

In 3GPP Rel-16, the basic SL communication functionalities are supported, and Rel-17 introduced more enhanced features into SL. One of Rel-17 features was an enhanced SL resource allocation mechanism by taking other UE's SL channel sensing result into account in addition to TX UE (UE who intends to transmit data/control over SL)'s own SL channel sensing. Other UE(s) can inform a TX UE of the set of preferred and/or not preferred resource information derived from its channel sensing by the control message which called as inter-UE coordination (IUC) information (INFO). IUC transmission can be initiated by other UE(s) itself or by TX UE's request. TX UE can send IUC Request (REQ) then other UE(s) responds IUC INFO accordingly.

The SL UE can support inter-UE coordination (IUC) in Mode 2, whereby a UE-A sends information about resources to UE-B, which UE-B then uses for resource (re)selection. The following schemes of inter-UE coordination are supported: (1) IUC scheme 1, where the coordination information sent from a UE-A to a UE-B is the preferred and/or non-preferred resources for UE-B's transmission, and (2) IUC scheme 2, where the coordination information sent from a UE-A to a UE-B is the presence of expected/potential resource conflict on the resources indicated by UE-B's SCI.

In scheme 1, IUC can be triggered by an explicit request from a UE-B, or by a condition at a UE-A. The UE-A determines the set of resources reserved by other UEs or slots where UE-A, when it is the intended receiver of the UE-B, does not expect to perform SL reception from UE-B due to half-duplex operation. The UE-A uses these resources as the set of non-preferred resources, or excludes these resources to determine a set of preferred resources and sends the preferred/non-preferred resources to UE-B. UE-B's resources for resource (re)selection can be based on both UE-B's sensing results (if available) and the coordination information received from the UE-A, or it can be based only on coordination information received from the UE-A. For scheme 1, MAC CE and second-stage SCI or MAC CE only can be used to send IUC. The explicit request and reporting for IUC in unicast manner is supported.

In scheme 2, the UE-A determines the expected/potential resource conflict within the resources indicated by UE-B's SCI as either resources reserved by other UEs and identified by the UE-A as fully/partially overlapping with the resources indicated by UE-B's SCI, or as slots where the UE-A is the intended receiver of the UE-B and does not expect to perform SL reception on those slots due to half-duplex operation. The UE-B uses the conflicting resources to determine the resources to be reselected and exclude the conflicting resources from the reselected resources. For scheme 2, PSFCH is used to send IUC.

An SCI format 2-C is used for the decoding of PSSCH, and providing inter-UE coordination information or requesting inter-UE coordination information.

The following information is defined as the information included in SCI format 2C:
HARQ process number—4 bits;
New data indicator—1 bit;
Redundancy version—2 bits as defined in 3GPP standard specification;
Source ID—8 bits as defined in 3GPP standard specification;
Destination ID—16 bits as defined in 3GPP standard specification;
HARQ feedback enabled/disabled indicator—1 bit as defined in 3GPP standard specification;
CSI request—1 bit as defined in 3GPP standard specification; and
Providing/Requesting indicator—1 bit, where value 0 indicates SCI format 2-C is used for providing inter-UE coordination information and value 1 indicates SCI format 2-C is used for requesting inter-UE coordination information.

If the “providing/requesting indicator” field is set to 0, all the remaining fields are set as follows: resource combinations—

$$2 \cdot ( ⌈ {log}_{2} ( \frac{{N}_{s u b C hannel}^{S L} ( {N}_{subChannel}^{S L} + 1 ) ( 2 {N}_{subChannel}^{S L} + 1 )}{6} ) ⌉ + 9 + Y )$$

bits as defined in 3GPP standard specification, where:
Y=┌log₂ N_{rsv_period}┌ and N_{rsv_period} period is the number of entries in the higher layer parameter sl-ResourceReservePeriodList, if higher layer parameter sl-MultiReserveResource is configured; Y=0; otherwise
N_{subChannel}^{SL} is the number of subchannels in a resource pool provided by the higher layer parameter sl-NumSubchannel;
First resource location—8 bits as defined in 3GPP standard specification;
Reference slot location—(10+┌log₂(10·2^{μ}) bits as defined in 3GPP standard specification, where μ is defined in 3GPP standard specification;
Resource set type—1 bit, where value 0 indicates preferred resource set and value 1 indicates non-preferred resource set; and
Lowest subChannel indices—2·┌log₂ N_{subChannel}^{SL}┐ bits as defined in 3GPP standard specification.

If the “providing/requesting indicator” field is set to 1, all the remaining fields are set as follows:
Priority—3 bits as specified in 3GPP standard specification. Value “000” of priority field corresponds to priority value “1,” value “001” of priority field corresponds to priority value “2,” and so on;
Number of subchannels—┌log₂ N_{subChanned┐ bits as defined in} 3GPP standard specification;
Resource reservation period—┌log₂ N_{rsv_period}┐ bits as defined in 3GPP standard specification, where N_{rsv_period} is the number of entries in the higher layer parameter sl-ResourceReservePeriodList, if higher layer parameter sl-MultiReserveResource is configured; 0 bit otherwise;
Resource selection window location −2·(10+┌log₂(10·2^{μ}┐) bits as defined in 3GPP standard specification, where μ is defined in 3GPP standard specification;
Resource set type—1 bit, where value 0 indicates a request for inter-UE coordination information providing preferred resource set and value 1 indicates a request for inter-UE coordination information providing non-preferred resource set, if higher layer parameter determineResourceSetTypeScheme1 is configured to “UE-B's request”; otherwise, 0 bit; and
Padding bits.

For an operation in the same resource pool, zeros may be appended to SCI format 2-C of which “providing/requesting indicator” field is set to 1 until the payload size equals that of SCI format 2-C of which “providing/requesting indicator” field is set to 0.

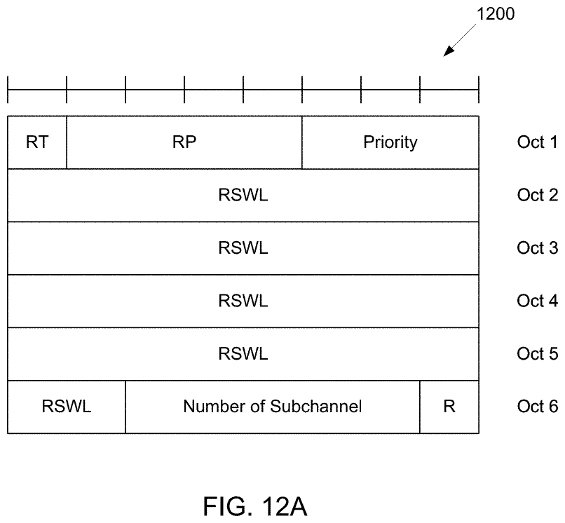

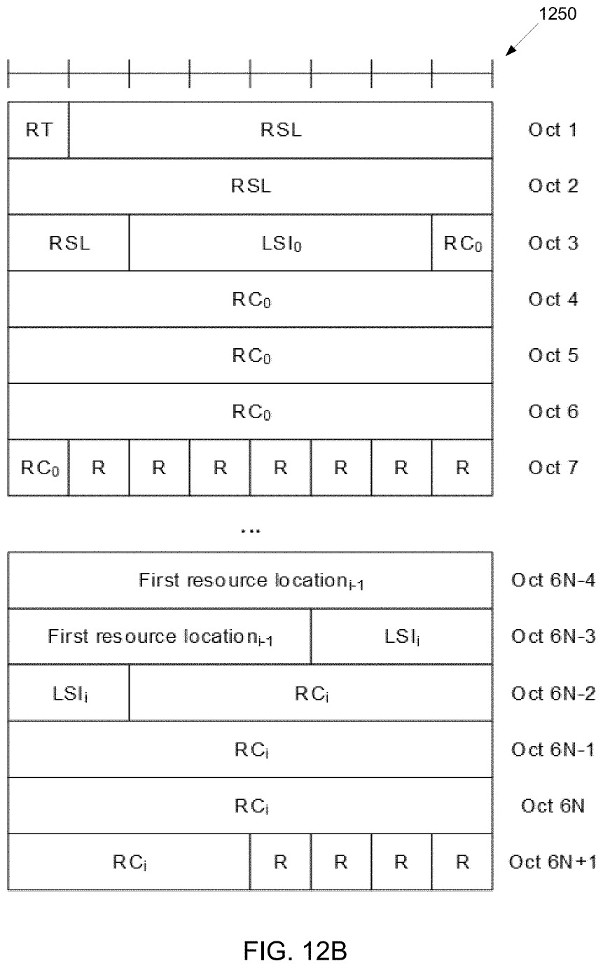

FIG. 12A illustrates an example of inter-UE coordination request MAC CE 1200 according to embodiments of the present disclosure. An embodiment of the inter-UE coordination request MAC CE 1200 shown in FIG. 12A is for illustration only.

FIG. 12A shows IUC REQ MAC CE. IUC REQ MAC CE is identified by a MAC subheader with LCID. The priority of the IUC REQ MAC CE is fixed to “1.”

It has a fixed size of 48 bits with following fields:
RT: If the value of sl-DetermineResourceType (as specified in 3GPP standard specification) is set to “ueb,” this field indicates the resource set type, i.e., preferred resource set or non-preferred resource set, as the codepoint value of the SCI format 2-C resourceSetType field as specified in 3GPP standard specification. This field is ignored if the value of sl-DetermineResourceType is set to “uea”;
RP: This field indicates the resource reservation period, as the codepoint value of the SCI format 2-C resourceReservationPeriod field as specified in 3GPP standard specification. The length of the field is 4 bits. If the length of resourceReservationPeriod field in SCI format 2-C as specified in 3GPP standard specification is shorter than 4 bit, this field contains resourceReservationPeriod field using the LSB bits;
Priority: This field indicates the priority, as the codepoint value of the SCI format 2-C priority field as specified in 3GPP standard specification. The length of the field is 3 bits;
RSWL: This field indicates resource selection window location, as the codepoint value of the SCI format 2-C resourceSelectionWindowLocation field as specified in 3GPP standard specification. The length of the field is 34 bits. If the length of resourceSelectionWindowLocation field in SCI format 2-C as specified in 3GPP standard specification is shorter than 34 bit, this field contains resourceSelectionWindowLocation field using the LSB bits;
Number of subchannel: This field indicates the number of subchannels, as the codepoint value of the SCI format 2-C numberOfSubchannel field as specified in 3GPP standard specification. The length of the field is 5 bits. If the length of numberOfSubchannel field in SCI format 2-C as specified in 3GPP standard specification is shorter than 5 bit, this field contains numberOfSubchannel field using the LSB bits; and
R: Reserved bit, set to 0.

FIG. 12B illustrates an example of inter-UE coordination information MAC CE 1250 according to embodiments of the present disclosure. An embodiment of the inter-UE coordination information MAC CE 1250 shown in FIG. 12B is for illustration only

FIG. 12B shows IUC MAC CE. IUC INFO MAC CE is identified by a MAC subheader with LCID. The priority of the IUC INFO MAC CE is fixed to “1.”

It has a variable size with following fields:
RT: This field indicates the resource set type, i.e., preferred resource set/non-preferred resource set, as the codepoint value of the SCI format 2-C resourceSetType field as specified in 3GPP standard specification;
RSL: This field indicates the location of reference slot, as the codepoint value of the SCI format 2-C referenceSlotLocation field as specified in 3GPP standard specification. The length of the field is 17 bits. If the length of referenceSlotLocation field in SCI format 2-C as specified in 3GPP standard specification is shorter than 17 bit, this field contains referenceSlotLocation field using the LSB bits;
LSIᵢ: This field indicates lowest subchannel indices for the first resource location of each TRIV, as the codepoint value of the SCI format 2-C lowestIndices field as specified in 3GPP standard specification. LSI₀ indicates lowest subchannel indices for the first resource location of TRIV within the first resource combination, LSI₁ indicates lowest subchannel indices for the first resource location of TRIV within the second resource combination and so on. The length of the field is 5 bits. If the length of lowestIndices field in SCI format 2-C as specified in 3GPP standard specification is shorter than 5 bit, this field contains lowestIndices field using the LSB bits;
RCᵢ: This field indicates resource combination, as the codepoint value of the SCI format 2-C resourceCombination field as specified in 3GPP standard specification. RC₀ indicates the first resource combination, RC₁ indicates the second resource combination and so on. The length of the field is 26 bits. If the length of resourceCombination field in SCI format 2-C as specified in 3GPP standard specification is shorter than 26 bit, this field contains resourceCombination field using the LSB bits;
First resource locationᵢ₋₁: This field indicates first resource location, as the codepoint value of the SCI format 2-C firstResourceLocation field as specified in 3GPP standard specification. First Resource Location₀ indicates the first resource location for the second resource combination, First Resource Location₁ indicates the first resource location for the third resource combination and so on. The length of the field is 13 bits. If the length of firstResourceLocation field in SCI format 2-C as specified in 3GPP standard specification is shorter than 13 bit, this field contains firstResourceLocation field using the LSB bits; and
R: Reserved bit, set to 0.

In Rel-18, more enhanced features can be introduced in SL and one of features may be carrier aggregation (CA). This embodiment provides an efficient SCI in SL CA.

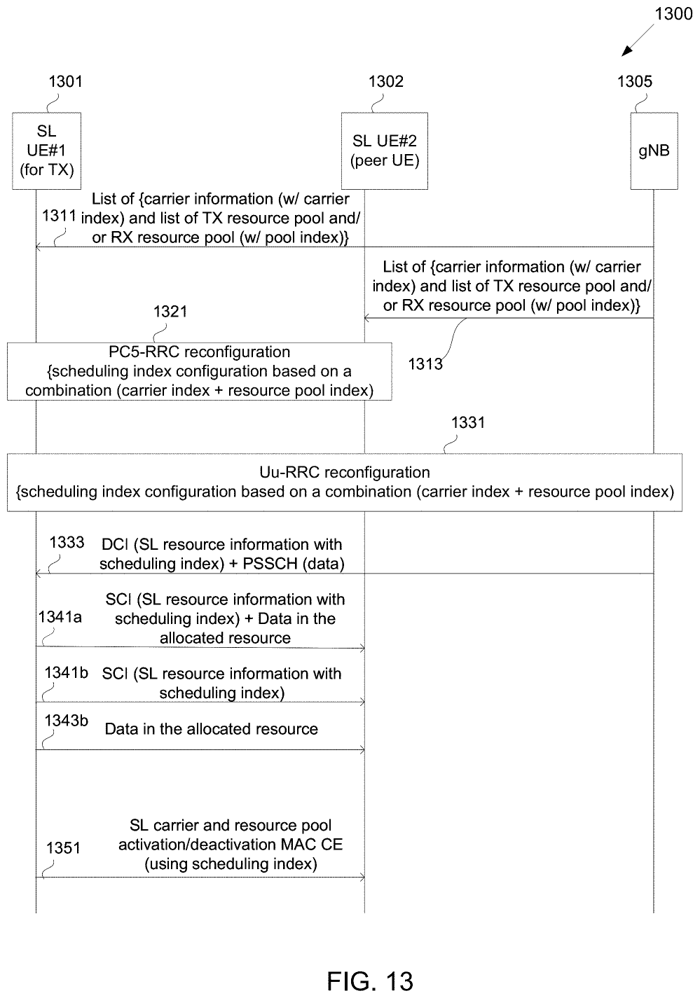

FIG. 13 illustrates a signaling flows 1300 of SL CA operation according to embodiments of the present disclosure. The signaling flows 1300 as may be performed by a UE (e.g., 111-116 as illustrated in FIG. 1) and a BS (e.g., 101-103 as illustrated in FIG. 1). An embodiment of the signaling flows 1300 shown in FIG. 13 is for illustration only. One or more of the components illustrated in FIG. 13 can be implemented in specialized circuitry configured to perform the noted functions or one or more of the components can be implemented by one or more processors executing instructions to perform the noted functions.

FIG. 13 describes an example of the embodiment. 1301 is an SL UE #1 who is configured for SL transmission (or who has data for SL transmission), 1302 is an SL UE #2 who is a peer UE of SL UE #1 1301 (or who is communication with the SL UE #1 1301 and/or not configured for SL transmission (or not has data for SL transmission), and 705 is a gNB who controls a serving cell of the SL UE #1 1301 and the SL UE #2 1302. Note a gNB who controls a serving cell of the SL UE #1 1301 and a gNB who controls a serving cell of the SL UE #2 1302 can be different one, but in the figure for description convenience, it is assumed the same gNB serves both of them.

For SL CA operation, the gNB 1305 configures TX resource pools and/or RX resource pools for each SL carrier for the SL UE #1 1301. Note the gNB 1305 can configures TX resource pools and/or RX resource pools for multiple SL carriers for the SL UE #1 1301 and/or the SL UE #2 1302 (e.g., 1311, 1313). Each TX resource pool and/or RX resource pool is configured with a resource pool index (or a pool id) and each SL carrier is configured with a carrier index (or a carrier id).

For example, let's assume three TX resource pools and/or three RX resource pools are configured for two SL carriers:
SL carrier with a carrier index #0 (let's call it as SL carrier #0):
   TX resource pool and/or RX resource pool with resource pool index #0 (let's call it as TX resource pool #0 and/or RX resource pool #0),
   TX resource pool and/or RX resource pool with resource pool index #1 (let's call it as TX resource pool #1 and/or RX resource pool #1), and
   TX resource pool and/or RX resource pool with resource pool index #2 (let's call it as TX resource pool #2 and/or RX resource pool #2); and
SL carrier with a carrier index #1 (let's call it as SL carrier #1):
   TX resource pool and/or RX resource pool with resource pool index #0 (let's call it as TX resource pool #0 and/or RX resource pool #0),
   TX resource pool and/or RX resource pool with resource pool index #1 (let's call it as TX resource pool #1 and/or RX resource pool #1), and
   TX resource pool and/or RX resource pool with resource pool index #2 (let's call it as TX resource pool #2 and/or RX resource pool #2).

As another example of the configuration for TX resource pools and/or RX resource pools for multiple SL carriers, instead of using SL carrier index, only resource pool index (or pool id) can be configured. In the case, it may guarantee that the same resource pool index is not used cross multiple SL carriers.

For example, let's assume three resource pools and/or three RX resource pools are configured for two SL carriers:
First SL carrier (let's call SL carrier #0):
   TX resource pool and/or RX resource pool with resource pool index #0 (let's call it as TX resource pool #0 and/or RX resource pool #0),
   TX resource pool and/or RX resource pool with resource pool index #1 (let's call it as TX resource pool #1 and/or RX resource pool #1), and
   TX resource pool and/or RX resource pool with resource pool index #2 (let's call it as TX resource pool #2 and/or RX resource pool #2); and
Second SL carrier (let's call SL carrier #1):
   TX resource pool and/or RX resource pool with resource pool index #0 (let's call it as TX resource pool #0 and/or RX resource pool #3),
   TX resource pool and/or RX resource pool with resource pool index #1 (let's call it as TX resource pool #1 and/or RX resource pool #4), and
   TX resource pool and/or RX resource pool with resource pool index #2 (let's call it as TX resource pool #2 and/or RX resource pool #5).

Note that, without explicit configurations for resource pool index (or pool id) and/or SL carrier index (or SL carrier id), the SL UE #1 1301 and/or the SL UE #2 1302 can derive resource pool index and/or SL carrier index based on the order of configuration. For example, the first SL carrier in the configuration is considered as the one with SL carrier index #0, the second SL carrier in the configuration is considered as the one with SL carrier index #1, the first TX resource pool and/or RX resource pool in each SL carrier is considered as the one with resource pool index #0, the second TX resource pool and/or RX resource pool in each SL carrier is considered as the one with resource pool index #1, the third TX resource pool and/or RX resource pool in each SL carrier is considered as the one with resource pool index #2, etc.

If SL carrier index is not used and only resource pool index is used (as described as another example in 1311 and 1313), the SL UE #1 1301 and/or the SL UE #2 1302 only derive resource pool index based on the order of configuration. For example, in the first SL carrier in the configuration, the first TX resource pool and/or RX resource pool is considered as the one with resource pool index #0, the second TX resource pool and/or RX resource pool is considered as the one with resource pool index #1, and the third TX resource pool and/or RX resource pool is considered as the one with resource pool index #2.

Then in the second SL carrier in the configuration, the first TX resource pool and/or RX resource pool is considered as the one with resource pool index #3, the second TX resource pool and/or RX resource pool is considered as the one with resource pool index #4, and the third TX resource pool and/or RX resource pool is considered as the one with resource pool index #5. 1311 and 1313 can be signalled by either system information block (SIB) or UE dedicated RRC message (e.g., RRC reconfiguration).

As illustrated in FIG. 13, it is assumed the SL UE #1 1301 and the SL UE #2 1302 are located in-coverage area, but for the case when the UEs are located out-of-coverage area, the information in 1311 and 1313 can be pre-configured by other network entity. Note that the TX and RX resource pools configured in 1311 and 1313 can be dedicated only for SL CA operation. In this case, the resource pools may be separately configured compared to Rel-16 and/or Rel-17 resource pools and only the UEs who can support SL CA operation can use the resource pools.

If SL communication between the SL UE #1 1301 and the SL UE #2 1303 is SL Unicast (UC), the UEs can establish PC5-RRC connection and can further limit (or configure) candidates of SL carriers and TX and/or RX resource pools for SL CA operation (1321). For example, if two SL carriers and three TX resource pools and/or three RX resource pools for each SL carrier are configured in 1311 and/or 1313, the SL UE #1 1301 and/or the SL UE #2 1302 can further limit candidate of SL carriers and TX and/or RX resource pools out of the configurations from 1311 and/or 1313.

For example, out of total six TX and/or RX resource pools in two SL carriers in 1311 and/or 1313, the UEs can further limit candidate SL carriers and TX and/or RX resource pools to three TX and/or RX resource pools as follow. Each further limited (configured) SL carriers and TX and/or RX resource pool will be configured with a scheduling index (or scheduling id).

Scheduling index can be either explicitly configured or implicitly configured based on the order of configurations:
SL carrier index #0, TX and/or RX resource pool index #1 (with scheduling index #0);
SL carrier index #1, TX and/or RX resource pool index #0 (with scheduling index #1); and
SL carrier index #1, TX and/or RX resource pool index #2 (with scheduling index #2).

Or if only resource pool index is used (as described as another example in 1311 and 1313):
TX and/or RX resource pool index #1 (with scheduling index #0);
TX and/or RX resource pool index #3 (with scheduling index #1); and
TX and/or RX resource pool index #5 (with scheduling index #2).

Note that the information in 1321 can be signalled by PC5-RRC reconfiguration and PC5-RRC reconfiguration complete. In mode 1 resource allocation, the gNB allocates the resource for SL transmission while in mode 2 resource allocation, the UE itself allocates the resource for SL transmission. When mode 1 resource allocation is applied and if the UE is in RRC connected state, the gNB can further limit (or configure) candidates of SL carriers and TX and/or RX resource pools for SL CA operation by UE dedicated RRC message, e.g., RRC reconfiguration (1331).

Note that 1331 may happen earlier than 1321 if 1321 is triggered by 1331. Note that if further limitation (or configuration) for candidate SL carriers and TX and/or RX resource pools is not done in 1321 and/or 1331, the SL UE #1 1301 and the SL UE #2 1302 consider the candidate SL carriers and TX and/or RX resource pools as the ones that are configured in 1311 and/or 1313 if the UE supports both carriers (for the interested service type or the interested L2 destination id).

Note that it may assume two SL carriers in 1311 and 1313, but if there are three SL carriers configured in 1311 and 1313 and the UE only supports last two SL carriers (for the interested service type or the interested L2 destination id), the UE only considers TX and/or RX resource pools in the last two SL carriers as candidates for SL CA operation. In the case, as another example the UE considers the SL carrier index and resource pool index starts from the first SL carrier in the configurations, which the UE supports (for the interested service type or the interested L2 destination id), e.g., SL carrier index #0 for the first SL carrier the UE supports and resource pool index #0 for the first TX and/or RX resource pool in that SL carrier.

In mode 1 resource allocation, the gNB allocates the resource for SL transmission to the SL UE #1 1301 (e.g., 1333). The allocated resource information in 1333 is signalled by DCI. If further limitation (or configuration) for candidate SL carriers and TX and/or RX resource pools is done in 1331, DCI includes the scheduling index indicating which SL carrier and which TX resource pool in the SL carrier is used for the allocated resource for SL transmission. If further limitation (or configuration) for candidate SL carriers and TX and/or RX resource pools is not done in 1331, DCI includes the SL carrier index indicating which SL carrier is used for the allocated resource and the resource pool index indicating which TX resource pool in the SL carrier is used for the allocated resource.

If SL carrier index is not used and only resource pool index is used (as described as another example in 1311 and 1313), DCI includes only resource pool index indicating which TX and/RX resource pool cross all candidate SL carriers is used for the allocated resource for SL transmission. As another example, the scheduling index (or the resource pool index and/or the SL carrier index) may not be included in DCI when the SL carrier for the allocated resource is same as the UL carrier (or when the SL carrier for the allocated resource is part of UL carrier) that corresponds to the DL carrier where the DCI is sent.

After resource allocation in mode 2 resource allocation or after 1331 in mode 1 resource allocation, the SL UE #1 1301 sends SCI to the SL UE #2 1302 in order to inform the allocated resource information (e.g., 1333). If further limitation (or configuration) for candidate SL carriers and TX and/or RX resource pools is done in 1321 in mode 2 resource allocation or the UE receives 1333 in mode 1 resource allocation, SCI includes the scheduling index indicating which SL carrier and which TX and/or RX resource pool is used for the allocated resource for SL transmission (in the SL UE #1 1301 point of view) or SL reception (in the SL UE #2 1302 point of view).

If further limitation (or configuration) for candidate SL carriers and TX and/or RX resource pool is not done in 1321 and/or 1331, SCI includes the SL carrier index indicating which SL carrier is used for the allocated resource and the resource pool index indicating which TX and/or RX resource pool in the SL carrier is used for the allocated resource. If SL carrier index is not used and only resource pool index is used (as described as another example in 1311 and 1313), SCI includes only resource pool index indicating which TX and/RX resource pool cross all candidate SL carriers is used for the allocated resource. As another example, the scheduling index (or the resource pool index and/or the SL carrier index) may not be included in SCI when the SL carrier and/or TX and/or RX resource pool for the allocated resource is same as the one where the SCI is sent.

1341a describes a case when a SCI and a data in the allocated resource by the SCI is sent at the same time. 1341b and 1343b describe a case a SCI is sent first then a data in the allocated resource by the SCI is sent in a time-gap after the SCI. It is because the SL UE #2 1302 may need more processing time to decode scheduling index (or the resource pool index and/or the SL carrier index) from SCI before the decoding of the data in the allocated resource. The length of time-gap can be fixed or configured or pre-configured. In the figure, it is assumed the scheduling index (or the resource pool index and/or the SL carrier index) in SCI to let the SL UE #2 1302 know the allocated resource for SL reception (in the SL UE #2 1302 point of view), but please note the scheduling index (or the resource pool index and/or the SL carrier index) in SCI is also used for channel sensing and resource allocation in other TX UEs (UEs who intends to perform SL transmission other than the SL UE #1 1301).

For example, the other TX UEs excludes the allocated resources indicated by scheduling index (or the resource pool index and/or the SL carrier index) from the candidate resources in the resource allocation for their SL transmission, and IUC-based resource allocation (in case of SCI format 2C), e.g., IUC REQ and/or IUC INFO via SCI format 2C includes the scheduling index (or the resource pool index and/or the SL carrier index) to indicate which SL carrier and which TX and/or RX resource pool in that SL carrier is used for IUC REQ and/or IUC INFO.

Note that, with the same reason, IUC REQ and/or IUC INFO MAC CE also includes the information field of the scheduling index (or the resource pool index and/or the SL carrier index). Note scheduling index (or the resource pool index and/or the SL carrier index) can be included in the existing SCI by using reserved field or different interpretation of existing field. Another example is to use new SCI format for SL CA operation.

1351 describes the case where new MAC CE is used in order to inform activation/deactivation for one of configured SL carriers and/or TX and/or RX resource pools which configured in 1311 or 1321/1331. The activation/deactivation MAC CE is identified by a MAC sub-header with a logical channel id value. The activation/deactivation MAC CE includes the scheduling index (or the resource pool index and/or the SL carrier index) with activate/deactivate indication. If the SL UE #2 1302 receives an activation for a SL carrier and/or TX and/RX resource pool, the UE start monitoring (or receiving) the activated SL carriers and/or TX and/RX resource pool. If the SL UE #2 1302 receives a deactivation for a SL carrier and/or TX and/RX resource pool, the UE stops monitoring (or receiving) the deactivated SL carriers and/or TX and/RX resource pool. Note as another example, the activation/deactivation can be included in SCI.

As another example, SL carrier index is only used without resource pool index, in the case the SL UE #2 1302 performs blind decoding for data reception, which based on CRC check, in the allocated resource from all configured RX resource pools within the indicated SL carrier.

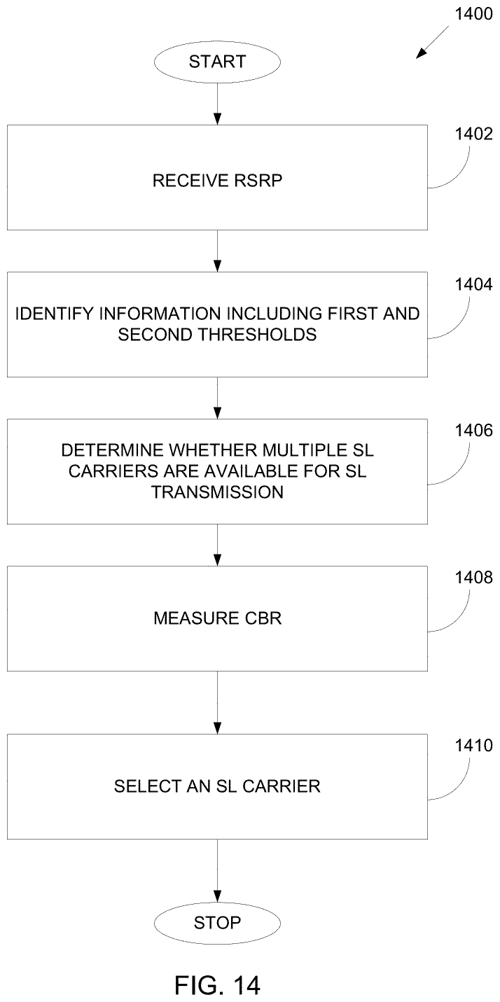

FIG. 14 illustrates a flowchart of a method 1400 for a (re)selection of candidate carriers for transmission in SL CA according to embodiments of the present disclosure. The method 1400 as may be performed by a UE (e.g., 111-116 as illustrated in FIG. 1). An embodiment of the method 1400 shown in FIG. 14 is for illustration only. One or more of the components illustrated in FIG. 14 can be implemented in specialized circuitry configured to perform the noted functions or one or more of the components can be implemented by one or more processors executing instructions to perform the noted functions.

As illustrated in FIG. 14, the method 1400 begins at step 1402. In step 1402, a UE receives, from a peer UE, an RSRP. In step 1404, the UE identifies information including a first threshold and a second threshold for a sidelink (SL) transmission. In step 1404, the information for the multiple SL carriers and the first and second thresholds are preconfigured as a system parameter. In step 1404, the multiple SL carriers are configured per SL service type or an L2 destination ID and the first threshold and the second threshold are configured per SL priority range.

In step 1406, the UE determines whether multiple SL carriers are available for the SL transmission. In step 1408, the UE measures, based on a determination that the multiple SL carriers are available, a CBR.

In step 1410, the UE selects an SL carrier from the multiple SL carriers for the SL transmission when the measured CBR is less than the first threshold and the received RSRP is greater than the second threshold.

In one embodiment, the UE receives, from the BS via system information or a UE dedicated RRC message, information for the multiple SL carriers and the information including the first threshold and the second threshold.

In one embodiment, the UE identifies information including a third threshold and a fourth threshold for the SL transmission and continuously uses the selected SL carrier when the measured CBR is less than the third threshold and the received RSRP is greater than the fourth threshold.

In one embodiment, the UE receives, via system information or a UE dedicated RRC message, indication information indicating whether to use the measured CBR or the received RSRP for selecting the SL carrier and selects, based on the indication information, the SL carrier from the multiple SL carriers for the SL transmission when the measured CBR is less than the first threshold or the received RSRP is greater than the second threshold.

In one embodiment, the UE receives, from the peer UE, a peer UE CBR that is measured by the peer UE, receives, from the, BS, a third threshold, and selects the SL carrier when the measured CBR is less than the first threshold and the received peer UE CBR is less than the third threshold.

In one embodiment, the UE schedules a SL resource based on a resource index included in SCI received from a BS, wherein the resource index indicates the selected SL carrier and a selected SL resource pool within the selected SL carrier.

In such embodiment, the resource index is configured with the peer UE using PC5-RRC reconfiguration information.

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A user equipment (UE) in a wireless communication system, the UE comprising:
a transceiver configured to receive, from a peer UE, a reference signal received power (RSRP); and
a processor operably coupled to the transceiver, the processor configured to:
identify information including a first threshold and a second threshold for a sidelink (SL) transmission,
determine whether multiple SL carriers are available for the SL transmission,
measure, based on a determination that the multiple SL carriers are available, a channel busy ratio (CBR), and
select a SL carrier from the multiple SL carriers for the SL transmission when the measured CBR is less than the first threshold and the received RSRP is greater than the second threshold.

2. The UE of claim 1, wherein the transceiver is further configured to receive, from the BS via system information or a UE dedicated radio resource control (RRC) message, information for the multiple SL carriers and the information including the first threshold and the second threshold.

3. The UE of claim 1, wherein information for the multiple SL carriers and the first and second thresholds are preconfigured as a system parameter.

4. The UE of claim 1, wherein:
the multiple SL carriers are configured per SL service type or a layer 2 (L2) destination identifier (ID); and
the first threshold and the second threshold are configured per SL priority range.

5. The UE of claim 1, wherein the processor is further configured to:
identify information including a third threshold and a fourth threshold for the SL transmission; and
continuously use the selected SL carrier when the measured CBR is less than the third threshold and the received RSRP is greater than the fourth threshold.

6. The UE of claim 1, wherein:
the transceiver is further configured to receive, via system information or a UE dedicated radio resource control (RRC) message, indication information indicating whether to use the measured CBR or the received RSRP for selecting the SL carrier; and
the processor is further configured to select, based on the indication information, the SL carrier from the multiple SL carriers for the SL transmission when the measured CBR is less than the first threshold or the received RSRP is greater than the second threshold.

7. The UE of claim 1, wherein:
the transceiver is further configured to:
receive, from the peer UE, a peer UE CBR that is measured by the peer UE, and
receive, from the, BS, a third threshold; and
the processor is further configured to select the SL carrier when the measured CBR is less than the first threshold and the received peer UE CBR is less than the third threshold.

8. The UE of claim 1, wherein:
the processor is further configured to schedule a SL resource based on a resource index included in SL control information (SCI) received from a BS; and
the resource index indicates the selected SL carrier and a selected SL resource pool within the selected SL carrier.

9. The UE of claim 8, wherein the resource index is configured with the peer UE using PC5-radio resource control (PC5-RRC) reconfiguration information.

10. A method of a user equipment (UE) in a wireless communication system, the method comprising:
receiving, from a peer UE, a reference signal received power (RSRP);
identifying information including a first threshold and a second threshold for a sidelink (SL) transmission;
determining whether multiple SL carriers are available for the SL transmission;
measuring, based on a determination that the multiple SL carriers are available, a channel busy ratio (CBR); and
selecting a SL carrier from the multiple SL carriers for the SL transmission when the measured CBR is less than the first threshold and the received RSRP is greater than the second threshold.

11. The method of claim 10, further comprising receiving, from the BS via system information or a UE dedicated radio resource control (RRC) message, information for the multiple SL carriers and the information including the first threshold and the second threshold.

12. The method of claim 10, wherein information for the multiple SL carriers and the first and second thresholds are preconfigured as a system parameter.

13. The method of claim 10, wherein:
the multiple SL carriers are configured per SL service type or a layer 2 (L2) destination identifier (ID); and
the first threshold and the second threshold are configured per SL priority range.

14. The method of claim 10, further comprising:
identifying information including a third threshold and a fourth threshold for the SL transmission; and
continuously using the selected SL carrier when the measured CBR is less than the third threshold and the received RSRP is greater than the fourth threshold.

15. The method of claim 10, further comprising:
receiving, via system information or a UE dedicated radio resource control (RRC) message, indication information indicating whether to use the measured CBR or the received RSRP for selecting the SL carrier; and
selecting, based on the indication information, the SL carrier from the multiple SL carriers for the SL transmission when the measured CBR is less than the first threshold or the received RSRP is greater than the second threshold.

16. The method of claim 10, further comprising:
receiving, from the peer UE, a peer UE CBR that is measured by the peer UE;
receiving, from the, BS, a third threshold; and
selecting the SL carrier when the measured CBR is less than the first threshold and the received peer UE CBR is less than the third threshold.

17. The method of claim 10, further comprising scheduling a SL resource based on a resource index included in SL control information (SCI) received from a BS, wherein the resource index indicates the selected SL carrier and a selected SL resource pool within the selected SL carrier.

18. The method of claim 17, wherein the resource index is configured with the peer UE using PC5-radio resource control (PC5-RRC) reconfiguration information.

19. A base station (BS) in a wireless communication system, the BS comprising:
a processor configured to generate information including a first threshold and a second threshold; and
a transceiver operably coupled to the processor, the transceiver configured to transmit, to a user equipment (UE), the information for a sidelink (SL) transmission that is performed over an SL carrier of multiple SL carriers,
wherein a channel busy ratio (CBR) is measured, by the UE, based on an availability of the multiple SL carriers for the SL transmission, and wherein the SL carrier is selected from the multiple SL carriers when the measured CBR is less than the first threshold and a reference signal received power (RSRP) that is received from a peer UE is greater than the second threshold.

20. The BS of claim 19, wherein the transceiver is further configured to:
transmit, to the UE via system information or a UE dedicated radio resource control (RRC) message, information for the multiple SL carriers and the information including the first threshold and the second threshold, or the information for the multiple SL carriers and the first and second thresholds being preconfigured as a system parameter;
transmit, to the UE, information including a third threshold and a fourth threshold for the SL transmission; and
transmit, to the UE via the system information or the UE dedicated RRC message, indication information indicating whether to use the measured CBR or the received RSRP for selecting the SL carrier.
